(19) United States
(12) Patent Application Publication
(10) Pub. No.: US 2002/0015551 A1
(43) Pub. Date: Feb. 7, 2002

(54) Optical switch network, optical cross connecting device, and optical add/drop multiplexer

(76) Inventors: Isao Tsuyama, Yokohama (JP); Satoshi Kuroyanagi, Kawasaki (JP); Ichiro Nakajima, Kawasaki (JP); Tetsuya Nishi, Kawasaki (JP)

Correspondence Address: STAAS & HALSEY LLP, 700 11TH STREET, NW, SUITE 500, WASHINGTON, DC, 20001, US

(21) Appl. No.: 09/908,623

(22) Filed: Jul. 20, 2001

(30) Foreign Application Priority Data
Jul. 21, 2000 (JP) 2000-220661
May 30, 2001 (JP) 2001-163235

(51) Int. Cl. G02B 6/35; H04J 14/02

(52) U.S. Cl. 385/17; 385/16; 385/24; 359/128

(57) ABSTRACT

The present invention aims at providing an optical switch network of lower loss, lower cost, downsized and superior expandability. To this end, one configuration of the optical switch network according to the present invention comprises a plurality of input ports, a plurality of output ports, a plurality of wavelength converting means provided corresponding to the plurality of input ports, respectively, for each converting a wavelength of light input from each of the input ports, and selecting means for outputting output lights from the plurality of wavelength converting means to particular ports of the output ports, respectively, corresponding to the wavelengths of the output lights. The optical switch network having such a configuration is free of provision of optical branching/coupling devices, therefore it is possible to achieve lower loss, downsized and superior expandability, as compared with conventional distributing and selecting type optical switch networks. According to another configuration of the optical switch network of the present invention, optical switching means for switching directional paths are arranged upstream and downstream of optical branching/coupling means, respectively, thereby enabling a smaller number of distributions at each optical branching/coupling means, to thereby achieve reduction of loss in the optical SW network.

### BACKGROUND OF THE INVENTION

(1) Field of the Invention

The present invention relates to an optical switch network for switching a wavelength division multiplexed optical signal, enabling to realize a lower loss, downsize and superior expandability, and more particularly, to an optical cross connecting device and an optical add/drop multiplexer each provided with this optical switch network.

(2) Related Art

Recently, there has been rapidly spread multimedia communication including the Internet. In the field of communication technology, to cope with a drastic increase of traffic amount due to such rapid spread, there have been eagerly studied and developed optical communication techniques for allowing super long-distance communications and large-capacity communications. In addition, to cope with a further increase of traffic amount, it is still being tried to increase the speed of time-division multiplexing (hereinafter abbreviated to “TDM”) transmission and to make the wavelength division multiplexing (hereinafter abbreviated to “WDM”) transmission to be high-density multiplexed.

Particularly, to flexibly cope with communications-related demands, it is required to constitute an optical transmission system not only in a one-to-one manner (i.e., point-to-point) but also in a many-to-many manner such as in a network. Thus, it is demanded to develop an optical cross connecting device, particularly, an optical switch network as a core of such an apparatus.

Conventionally, an optical switch network is constituted to include a light distributing section, a plurality of wavelength selecting sections and a plurality of wavelength conversion sections. An optical branching/coupling device (optical coupler), for example, is used as the light distributing section, for distributing an input WDM optical signal to the number of output ports. The WDM optical signal is a signal which is wavelength-multiplexed with a plurality of optical signals having wavelengths different from one another. The plurality of wavelength selecting sections are connected to the outputs of the light distributing section, respectively, so as to select arbitrary wavelengths from the WDM optical signal. An optical filter, for example, is used as each wavelength selecting section. Each one of the plurality of wavelength conversion sections is connected to the corresponding one of the wavelength selecting sections, so as to change the wavelength of input light into an arbitrary wavelength. Used as each wavelength conversion section is, for example, a device for once converting an optical signal into an electrical signal, and then converting it into an optical signal of a predetermined wavelength, like an O/E-E/O or a device utilizing four wave mixing.

The optical switch network having the aforementioned constitution is an optical switch network of distributing and selecting type, in which: the input WDM optical signal is distributed into the number of output ports by the light distributing section; those optical signals of the wavelengths having information to be output to output ports are selected from the distributed WDM optical signals, respectively, by the wavelength selecting sections; and those optical signals of the selected wavelengths are wavelength-converted to wavelengths to be output to the output ports, respectively, by the wavelength conversion sections. The optical switch network changes the directional paths of the optical signals input in such a manner.

In the present specification, so as to distinguish an optical switch as a switchboard type switch from an optical switch as an individual component for merely transmitting/blocking light, the switchboard type switch shall be called “optical switch network (or “optical SW network”) and the optical switch as the individual component shall be merely called optical switch (or SW)”.

Meantime, in the conventional optical switch network, there are inevitably used a lot of optical components which cause relatively large loss, such as optical branching/coupling devices (optical couplers), optical switches and optical filters. As a specific example, in the optical coupler to be used as the aforementioned light distributing section, there is caused at least a loss due to the distribution as represented by the following equation (1):

distribution loss=3×log₂N[dB] (1)

wherein N is the number of distributions.

As above, the conventional optical switch network has such a problem that the distribution loss is necessarily increased if the WDM optical signal is made to be high-density multiplexed. For example, the wavelength multiplexing of 128 waves leads to a distribution loss on the order of 30 dB in the aforementioned optical coupler. This corresponds to a length of about 100 km or more in terms of a transmission distance of 1.3 μm-band single-mode optical fiber, and thus means that the transmission distance is shortened by about 100 km. To mitigate such a limitation due to distribution loss, it is desired to realize a constitution of an optical switch network excluding optical couplers, or to reduce the number of distributions in the optical coupler (i.e., the number of ports of the optical coupler).

On the other hand, if an optical amplifier is introduced into the optical switch network to compensate for distribution loss and the like, there is caused such problems of: an occurrence of noise due to amplified spontaneous emission (ASE) light from the optical amplifier, the necessity of the optical amplifier to cope with a wide wavelength band; and an increase of the power consumption of the optical amplifier. This results in an increased cost and affects the environment.

Further, in the optical switch network of conventional constitution, if the WDM optical signal is coped with the high-density multiplexing, the number of optical branching/coupling devices of the light distributing section, the number of optical filters or the like of the wavelength selecting sections, and the number of wavelength conversion sections are increased, thereby causing a problem of a hugely increased size of the optical switch network and an increased cost thereof. This results in a problem of a hugely increased size of optical cross connecting device and an increased cost thereof.

Moreover, the operating amount of the optical switch network is typically increased by users after introduction of the network, corresponding to the increase of the traffic amount. Thus, the optical switch network is also required to have expandability to such an operating amount increase.

### SUMMARY OF THE INVENTION

The present invention has been achieved in view of the problems as described above, and it is therefore an object of the present invention to realize an optical switch network with lower loss, downsize, lower cost and superior expandability, and to provide an optical cross connecting device and an optical add/drop multiplexer each adopting this optical switch network.

A first aspect of the optical switch network according to the present invention is constituted to comprise: a plurality of input ports; a plurality of output ports; a plurality of wavelength converting means provided corresponding to the plurality of input ports, respectively, for each converting a wavelength of light input from each of the input ports; and selecting means for outputting output lights from the plurality of wavelength converting means to particular ports of the output ports, respectively, corresponding to the wavelengths of the output lights. Here, the number of input ports may be the same as or different from the number of output ports.

In the optical switch network, the constitution may be such that a plurality of selecting means and a plurality of optical switches are provided, to switch the outputs from the plurality of wavelength converting means to arbitrary ones of the plurality of selecting means, respectively.

According to the first aspect of the optical switch network, since directional paths of lights input to the input ports are controlled corresponding to the wavelengths of the lights converted by the variable wavelength converting means, it is possible to constitute the optical switch network without using optical branching/coupling devices. This theoretically avoids an occurrence of loss represented by the aforementioned equation (1). Thus, the optical switch network of the present invention is of lower loss, downsize, lower cost and superior expandability.

A second aspect of the optical switch network according to the present invention is constituted to comprise: a plurality of input ports; a plurality of output ports; a plurality of wavelength converting means provided corresponding to the plurality of input ports, respectively, for each converting a wavelength of light input from each of the input ports; a plurality of optical branching/coupling means arranged between the plurality of wavelength converting means and the plurality of output ports; input side optical switching means for sending the light wavelength converted by each wavelength converting means to any one of the plurality of optical branching/coupling means corresponding to the wavelength of the light after conversion and the output port set as an output destination; and output side optical switching means for sending the light output from each of the plurality of optical branching/coupling means to any one of the plurality of output ports corresponding to the optical branching/coupling means which has output the light and the wavelength of the output light. Also herein, the number of input ports may be the same as or different from the number of output ports.

According to the second aspect of the optical switch network, the lights input to the input ports are wavelength converted by the wavelength converting means, respectively, and then selectively sent to the optical branching/coupling means by the input side optical switching means, and the output lights from the optical branching/coupling means are selectively sent to the output ports by the output side optical switching means. In this way, the optical switching means are arranged upstream and downstream of the optical branching/coupling means, respectively, thereby allowing a smaller number of distributions at each optical branching/coupling means, so that a reduction of loss in the optical switch network can be achieved.

The optical cross connecting device according to the present invention comprises: wavelength-separating means for wavelength-separating a wavelength division multiplexed light; an optical switch network including a plurality of input ports to which a plurality of outputs of the wavelength-separating means are connected, respectively; a plurality of fixed wavelength converting means provided corresponding to a plurality of output ports of the optical switch network, for converting wavelengths of lights; and a plurality of wavelength-multiplexing means for wavelength-multiplexing output lights from the plurality of fixed wavelength converting means, respectively, wherein the optical switch network is applied with the aforementioned first aspect or second aspect of the present invention.

The optical add/drop multiplexer according to the present invention comprises: a dropping section for dropping predetermined optical signals from a wavelength division multiplexed optical signal comprising a plurality of optical signals having been wavelength-multiplexed; an adding section for adding predetermined optical signals into the wavelength division multiplexed optical signal output from the dropping section; and a first optical switch network for changing directional paths of the predetermined optical signals output from the dropping section into predetermined directional paths; and a second optical switch network for changing directional paths of optical signals input thereto, to output the input optical signals to the adding section, wherein each of the first optical switch network and the second optical switch network are applied with the aforementioned first aspect or second aspect of the present invention.

The aforementioned optical cross connecting device and optical add/drop multiplexer according to the present invention, and the optical network constructed by utilizing them can be realized by simply adding the aforementioned optical switch network according to the present invention thereto, thereby realizing constitutions having superior expandability.

Other objects, features and advantages of the present invention will become more apparent from the following description of preferred embodiments of the present invention when read in conjunction with the accompanying drawings.

### BRIEF DESCRIPTION OF THE DRAWINGS

FIG. 1 is a diagram showing a configuration of an optical SW network of an embodiment 1-1 of the present invention;

FIG. 2 is a diagram showing a configuration of an optical SW network of an embodiment 1-2 of the present invention;

FIG. 3 is a diagram showing a configuration and an input/output relationship of an m×m multiplexing/demultiplexing device in the SW network of the embodiment 1-2;

FIG. 4 is a diagram showing another configuration example of an m×m multiplexing/demultiplexing device in the SW network of the embodiment 1-2;

FIG. 5 is a diagram showing a configuration of a variable wavelength conversion section in the SW network of the embodiment 1-2;

FIG. 6 is a diagram showing a configuration of an optical SW network of an embodiment 1-3 of the present invention;

FIG. 7 is a diagram showing a configuration of an optical SW network of an embodiment 1-4 of the present invention;

FIG. 8 is a diagram showing a configuration of an n×n optical SW network in a D×D optical SW network of the embodiment 1-4;

FIG. 9 is a diagram showing a configuration of an optical cross connecting device of an embodiment 1-5 of the present invention;

FIG. 10 is a diagram showing a configuration of an optical cross connecting device of an embodiment 1-6 of the present invention;

FIG. 11 is a diagram showing a configuration of an optical cross connecting device of an embodiment 1-7 of the present invention;

FIG. 12 is a diagram showing a configuration of a 128×128 optical SW network in the optical cross connecting device of the embodiment 1-7;

FIG. 13 is a diagram showing a configuration of an optical cross connecting device of an embodiment 1-8 of the present invention;

FIG. 14 is a diagram showing a configuration of an optical network of an embodiment 1-9 of the present invention;

FIG. 15 is a diagram showing a configuration of an optical add/drop multiplexer in the optical network of the embodiment 1-9;

FIG. 16 is a diagram showing a configuration of an optical network of an embodiment 1-10 of the present invention;

FIG. 17 is a diagram showing a configuration of an optical add/drop multiplexer in the optical network of the embodiment 1-10;

FIG. 18 is a diagram showing a configuration of an optical SW network of an embodiment 2-1 of the present invention;

FIG. 19 is a diagram showing a configuration of generalized optical SW network of the embodiment 2-1;

FIG. 20 is a diagram showing an application example of the optical SW network of the embodiment 2-1;

FIG. 21 a diagram showing a configuration of an optical SW network of an embodiment 2-2 of the present invention;

FIG. 22 is a diagram showing a configuration of generalized optical SW network of the embodiment 2-2;

FIG. 23 is a diagram showing an application example of the optical SW network of the embodiment 2-2;

FIG. 24 is a diagram showing a configuration of an optical cross connecting device of an embodiment 2-3 of the present invention;

FIG. 25 is a diagram showing a configuration of an optical cross connecting device of an embodiment 2-4 of the present invention;

FIG. 26 is a diagram showing an example of a 256×256 optical SW network applied with a conventional constitution; and

FIG, 27 is a diagram showing another example of a 256×256 optical SW network applied with a conventional constitution.

### DETAILED DESCRIPTION OF THE PREFERRED EMBODIMENT

There will be described hereinafter embodiments according the present invention, with reference to the accompanying drawings. In the respective figures, identical elements are denoted by same reference numerals and explanations thereof are omitted.

Firstly, an embodiment 1-1 of the present invention will be described.

This embodiment 1-1 is an embodiment of an m×m optical switch network, for example, corresponding to a first embodiment of an optical switch network according to the present invention.

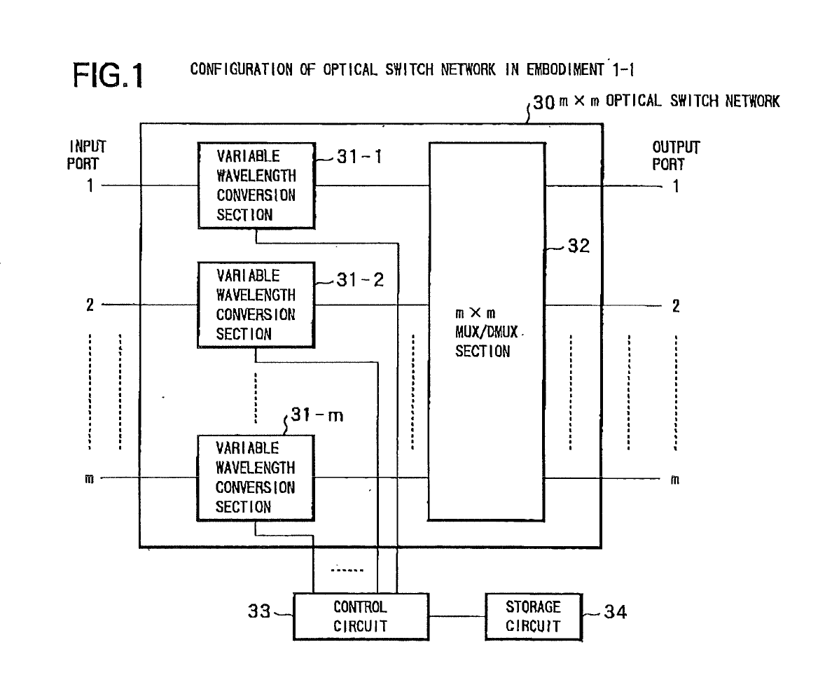

FIG. 1 is a diagram showing a configuration of the optical SW network of the embodiment 1-1.

In FIG. 1, m numbers of input ports are connected to plural m numbers of variable wavelength conversion sections 31, respectively, in a one-to-one manner.

The variable wavelength conversion sections 31 convert wavelengths of input optical signals into predetermined wavelengths, in accordance with control signals from a control circuit 33. The number of predetermined wavelengths can be arbitrarily changed in a range between 1 and r (r≦m).

The outputs of the plural m numbers of variable wavelength conversion sections 31 are connected to plural m numbers of inputs of an m×m multiplexing/demultiplexing (hereinafter abbreviated to “MUX/DMUX”) section 32, respectively, in a one-to-one manner.

The m×m MUX/DMUX section 32 is capable of dealing with plural r numbers of optical signals having mutually different wavelengths, and output positions thereof are uniquely determined corresponding to input positions to which the optical signals are input and wavelengths of the optical signals. The m×m MUX/DMUX section 32 is a selecting section for outputting the lights output from the variable wavelength conversion sections 31 to particular output ports corresponding to the wavelengths of the output lights, respectively.

The plural m numbers of outputs of the m×m MUX/DMUX section 32 are connected to the plural m numbers of output ports, respectively, in a one-to-one manner,

A storage circuit 34 such as a memory stores a wavelength-dependency input/output correspondence table showing corresponding relationships between input positions and wavelengths of input lights, and output positions in the m×m MUX/DMUX section 32.

The control circuit 33 such as a microprocessor is connected to the storage circuit 34 to thereby control the wavelengths to be converted by the variable wavelength conversion sections 31, by referring to the wavelength-dependency input/output correspondence table.

Here, the numbers m and r are positive integers, respectively. Further, in the multiplexing/demultiplexing device, SW's and the like, the notation “A×B” represents that the number of input ports is A and the number of output ports is B.

There will be described hereinafter the functions and effects of the embodiment 1-1.

An optical signal of wavelength λa is input to an input port b.

The control circuit 33 identifies the input port b to which this optical signal is input. The control circuit 33 reads routing information indicating a directional path of this optical signal, to thereby identify an output port c from which this optical signal is to be output.

The above identification can be performed such as by providing each input port with an optical branching device and an optical receiver for receiving an optical signal, to branch and receive a part of the optical signal, so that the routing information is read out therefrom. Further, the control circuit thus is possible not only to receive the routing information, but also to identify the input port b based on the optical receiver from which the routing information has been received.

The control circuit 33 refers to the wavelength-dependency input/output correspondence table in the storage circuit 34, to determine a wavelength λd to be input to the input of the m×m MUX/DMUX section 32, to which the input port b is connected via a variable wavelength conversion section 31-b, based on the positions of the input port b and output port c.

The control circuit 33 outputs to the variable wavelength conversion section 31-b connected to the input port b, a control signal for converting the wavelength of the optical signal into the wavelength λd.

The variable wavelength conversion section 31-b converts of the wavelength of the optical signal from the wavelength λa into the wavelength λd based on the control signal, and outputs the converted optical signal to the m×m MUX/DMUX section 32.

The converted optical signal is input to the m×m MUX/DMUX section 32, wherein the directional path of the optical signal is changed, to be output from the output connected to the output port c.

Further, the description will be made for such a situation that, in a case the optical signal of the wavelength λa input to the input port b is requested to be output from the output port c, simultaneously with this, an optical signal of a wavelength λe input to an input port f (f≢b) is requested to be output from an output port g (g≢c).

In this situation, the control circuit 33, similarly in the above, refers to the wavelength-dependency input/output correspondence table, to determine a wavelength λh to be input to the input of the m×m MUX/DMUX section 32, to which the input port f is connected via a variable wavelength conversion section 31-f, based on the positions of the input port f and output port g, so that the variable wavelength conversion section 31-f converts the wavelength of the input optical signal from the wavelength λe into the wavelength λh. The converted optical signal from the input port f is input to the m×m MUX/DMUX section 32, wherein the directional path of the optical signal is changed, to be output from the output connected to the output port g.

In this way, the control circuit controls wavelengths of different two optical signals, so that the directional paths of the optical signals can be duly changed, respectively. Also, even when three or more optical signals are simultaneously input, the directional paths thereof can be duly changed, respectively.

As described above, the m×m optical SW network in the embodiment 1-1 is a fully nonobstructive optical SW network capable of outputting the optical signals input to input ports from predetermined output ports, respectively.

In the above description of the functions and effects, the relationships are 1≦a, d, e, h≦r, and 1≦b, c, f, g≦m.

In the embodiment 1-1, although all of the inputs and outputs of the m×m MUX/DMUX section have been used, all of the inputs and outputs are not necessarily used. In this case, the number of input ports may be different from the number of output ports.

An embodiment 1-2 of the present invention will be described hereinafter.

This embodiment 1-2 is an embodiment of an n×n optical SW network.

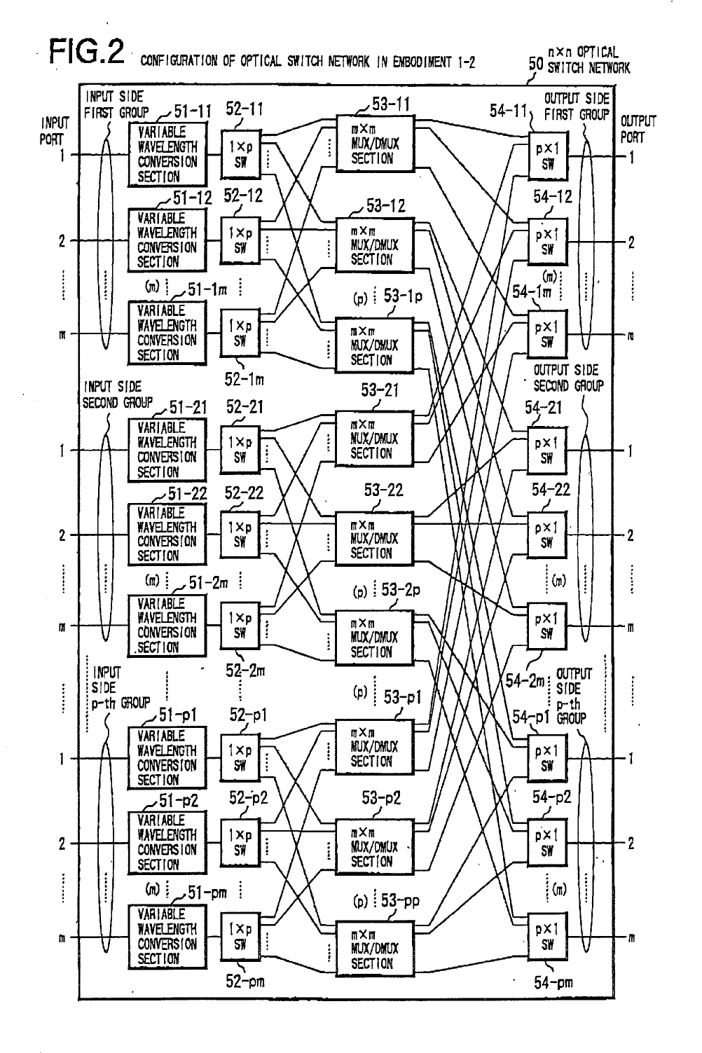

FIG. 2 is a diagram showing a configuration of the optical SW network of the embodiment 1-2.

In FIG. 2, an optical SW network 50 is constituted to comprise: n numbers of input ports, n numbers of variable wavelength conversion sections 51, n numbers of 1×p SW's 52, p·p numbers of m×m MUX/DMUX sections 53, n numbers of p×1 SW's 54, and n numbers of output ports.

Here, n, p and m are positive integers, respectively, and satisfy the relationship represented by the following equation (2):

n=p·m (2).

Note, the mark “·” represents multiplication identically to the normal mathematic operator, and thus may be omitted.

The n numbers of input ports are connected to the n numbers of 1×p SW's 52 via the variable wavelength conversion sections 51, respectively.

These n numbers of input ports are divided into p groups, such that m numbers are virtually regarded as one bundle. Note, when the optical signals to be input to the n×n optical SW network 50 are WDM optical signals, it is possible to consider that m corresponds to the multiplicity m, and that p corresponds to the number of optical transmission paths to be connected to the optical SW network 50.

Each of the variable wavelength conversion sections 51 is capable of converting the wavelength of the optical signal input from the associated input port into any one of m numbers of wavelengths which can be processed by the n×n optical SW network 50, such as λ1 to A m. The details thereof will be described later.

In 1×p SW's 52 of each group, the p numbers of outputs of a certain 1×p SW 52 are connected to p numbers of m×m MUX/DMUX sections 53 in a one-to-one manner.

Namely, in the first group, a first output of a first 1×p SW 52-11 is input to a first input of a first m×m MUX/DMUX section 53-11, and a second output of the first 1×p SW 52-11 is input to a first input of a second m×m MUX/DMUX section 53-12, and so on. Lastly, a p-th output of the first 1×p SW 52-11 is input to a first input of a p-th m×m MUX/DMUX section 53-1p. Further, in the first group, a first output of a second 1×p SW 52-12 is input to a second input of the first m×m MUX/DMUX section 53-11, and a second output of the second 1×p SW 52-12 is input to a second input of the second m×m MUX/DMUX section 53-12, and so on. Lastly, a p-th output of the second 1×p SW 52-12 is input to a second input of the p-th m×m MUX/DMUX section 53-1p. The same rule is applied correspondingly thereafter, so that a p-th output of an m-th 1×p SW 52-1m in the first group is m-th input to a p-th m×m MUX/DMUX section 53-1p. In each group, connections are conducted in the same manner as the above, so that a p-th output of an m-th 1×p SW 52-km in a k-th group is m-th input to a p-th m×m MUX/DMUX section 53-kp.

Each m×m MUX/DMUX section 53 is a cyclic matrix switch for selecting an output port, in accordance with a port position to which an optical signal is input, and a wavelength of the input optical signal. The details thereof will be described later.

Further, each output port of each m×m MUX/DMUX section 53 is connected with the p×1 SW 54.

In each m×m MUX/DMUX section 53 of each group, m numbers of outputs of the m×m MUX/DMUX section 53 are connected to p×1 SW's 54 in a one-to-one manner, such that each m×m MUX/DMUX section 53 is connected to each group of the output side. Namely, m numbers of outputs of a first m×m MUX/DMUX section 53-11 in the first group are connected to m numbers of p×1 SW's 54-11 to 54-1m in the first group, respectively. Further, m numbers of outputs of a second m×m MUX/DMUX section 53-12 in the first group are connected to m numbers of p×1 SW's 54-21 to 54-2m in the second group, respectively. The same rule is applied correspondingly thereafter, so that m numbers of outputs of a p-th m×m MUX/DMUX section 53-1p in the first group are connected to m numbers of p×1 SW's 54-p1 to 54-pm in a p-th group, respectively. m numbers of outputs of a first m×m MUX/DMUX section 53-21 in the second group are connected to the m numbers of p×1 SW's 54-11 to 54-1m in the first group, respectively. m numbers of outputs of a second m×m MUX/DMUX section 53-22 in the second group are connected to the m numbers of p×1 SW's 54-21 to 54-2m in the second group, respectively. The same rule is applied correspondingly thereafter, so that m numbers of outputs of a p-th m×m MUX/DMUX section 53-2p in the second group are connected to the m numbers of p×1 SW's 54-p1 to 54-pm in the p-th group, respectively. The same rule is applied correspondingly thereafter, so that m numbers of outputs of a p-th m×m MUX/DMUX section 53-rp in a r-th group are connected to the m numbers of p×1 SW's 54-p1 to 54-pm in the p-th group, respectively.

In the above description, the number (=p) of output groups and the number (=n) of output ports are set to correspond to each other, but can be set to be different from each other. Namely, in a case the number of output ports is set to j and the number of output groups is set to k, then the following equation (3) shall be satisfied assuming that J and k are positive integers, respectively:

n=p·m=k·j (3).

The storage circuit (not shown) stores therein, for example: a wavelength-dependency input/output correspondence table showing corresponding relationships between, input positions and wavelengths of input lights, and output positions, in the m×m MUX/DMUX section 53; and a relationship table, for connecting the input ports and output ports, showing relationships among the variable wavelength conversion sections 51, 1×p SW's 52, m×m MUX/DMUX sections 53 and p×1 SW's 54. The control circuit (not shown) is connected to the storage circuit to thereby control the variable wavelength conversion sections 51, 1×p SW's 52, m×m MUX/DMUX sections 53 and p×1 SW's 54, by referring to the respective tables.

Next, the m×m MUX/DMUX section 53 will be described hereinafter.

As such an m×m MUX/DMUX section 53, it is possible to adopt an m×m arrayed waveguide grating (hereinafter abbreviated to “AWG”) type optical multiplexing/demultiplexing device. The AWG is a generally known optical element, and one example thereof will be described hereinafter.

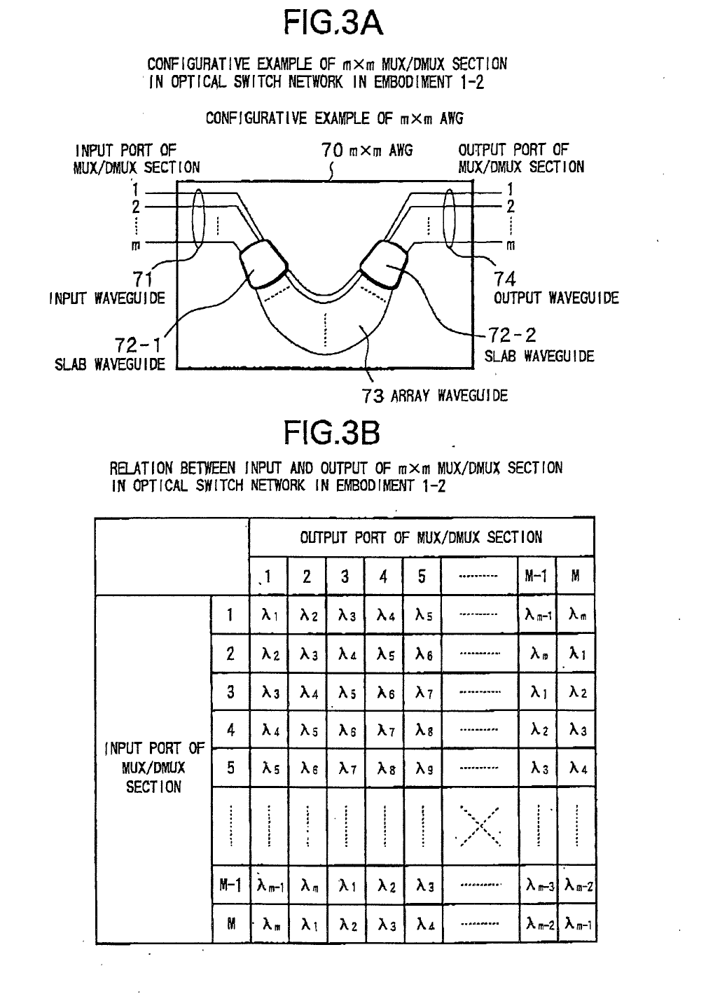

FIG. 3 is a diagram showing a configuration and an input/output relationship of an m×m multiplexing/demultiplexing device.

FIG. 3A is a diagram showing a configuration of an m×m AWG, and FIG. 3B is a diagram showing an input/output relationship of the m×m AWG.

In FIG, 3A, an AWG 70 is constituted to comprise m numbers of input waveguides 71, two numbers of slab waveguides 72, m numbers of arrayed waveguides 73 and m numbers of output waveguides 74.

Light propagated through an arbitrary input waveguide 71 is input to a slab waveguide 72-1, spread thereby, and then introduced into a group of arrayed waveguides 73. The respective arrayed waveguides 73 are set so that an optical path length difference between the adjacent two waveguides becomes constant. In the arrayed waveguide 73, the light at a certain wavelength reaches an input side of a slab waveguide 72-2 while obtaining a certain inclination of the wave surface, to establish a focus at a corresponding output side waveguide for coupling. Wave surface inclinations vary wavelength by wavelength, so that focus establishing positions, i.e., output waveguides 74, are varied wavelength by wavelength.

In the m×m AWG 70 having such a constitution, the relationship between the input side and output side, as shown in FIG. 38, are such that the output waveguides 74 are cyclically selected corresponding to the wavelengths of the lights to be input to the input waveguides 71, respectively.

Assuming now that a number of input port is Input-N, a number of output port is Output-N, and a number of wavelength is Wavelength-N, where the m waves of lights of mutually different wavelengths (λ1 to λm) are numbered in an ascending order (or descending order). Then, the relationships between output ports and input ports are given by the following equation (4), based on wavelengths of lights:

Output-N=Wavelength-N−Input-N+1, where (Input-N+Output-N)≦m+1, and

Output-N=Wavelength-N−Input-N+m+1, where (Input-N+Output-N)>m+1 (4).

Namely, the light of the wavelength λ1 (Wavelength-N=1) input to the input waveguide 71-1 of an input port 1 is output from an output port 1 of the output waveguide 74-1. The light of the wavelength λ2 (Wavelength-N=2) input to the input waveguide 71-1 of the input port 1 is output from an output port 2 of the output waveguide 74-2. The light of the wavelength λ3 (Wavelength-N=3) input to the input waveguide 71-1 of the input port 1 is output from an output port 3 of the output waveguide 74-3. The same rule is applied correspondingly thereafter, so that the light of the wavelength λm (Wavelength-N=m) input to the input waveguide 71-1 of the input port 1 is output from an output port m of the output waveguide 74-m.

Further, if the position of the input port is shifted by one from the input port 1 to the input port 2, the output port is also shifted by one in such a cyclic manner that the output port 1 comes again next to the output port m. Namely, the light of the wavelength λ1 input to an input waveguide 71-2 of an input port 2 is output from the output port m of the output waveguide 74-m. The light of the wavelength λ2 input to the input waveguide 71-2 of the input port 2 is output from an output port 1 of an output waveguide 74-1. The light of the wavelength λ3 input to the input waveguide 71-2 of the input port 2 is output from the output port 2 of the output waveguide 74-2.

Thereafter, the positions of the output ports are cyclically shifted in the same manner with the above, corresponding to the positions of input ports and to wavelengths to be input thereto, respectively. As seen from FIG. 3B, even when all the input ports are input with lights of the same wavelengths, respectively, the optical signals are output from mutually different output ports, respectively

The m×m MUX/DMUX section 53 having such a constitution is to multiplex/demultiplex the input lights by utilizing optical characteristics and structures, so that the directional paths of input fights can be switched within the time lengths required by the input lights for being propagated through the optical paths, respectively. This enables to switch the directional paths of input lights in an extremely short period of time.

The relationships between inputs and outputs depending on the wavelengths in the m×m MUX/DMUX section 53 as shown in FIG. 3B are stored as the wavelength-dependency input/output correspondence table in the storage circuit.

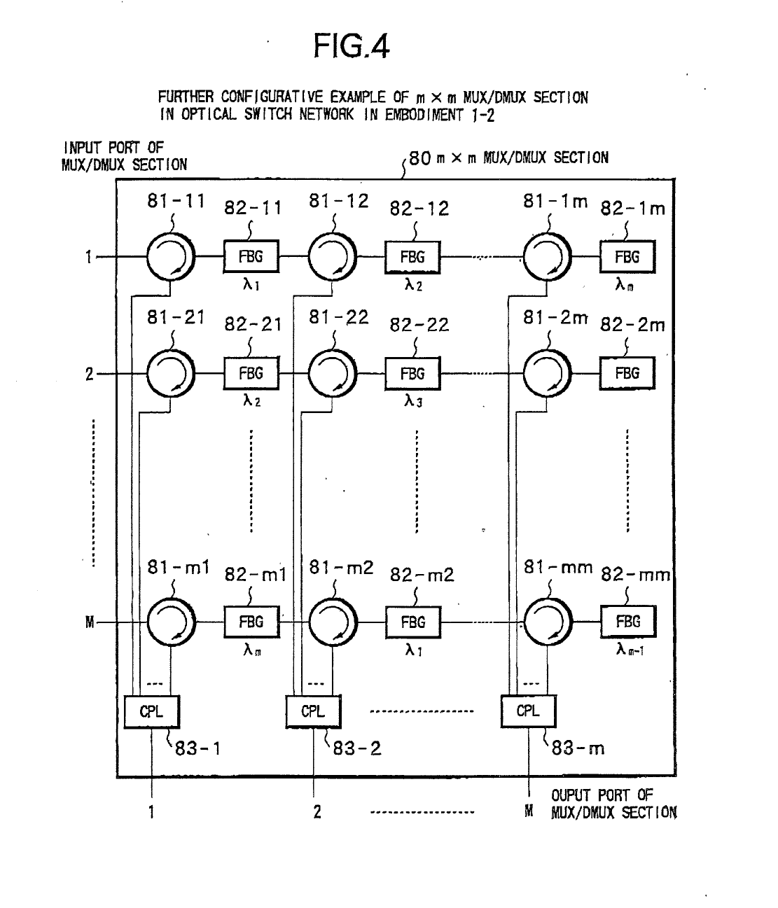

Such as shown in FIG. 4, the m×m MUX/DMUX section 53 may be constituted to comprise m·m numbers of optical circulators (hereinafter abbreviated to “OC's”) 81, m·m numbers of fiber grating filters (hereinafter abbreviated to “FBG's”) 82, and m numbers of optical branching/coupling devices (hereinafter abbreviated to “CPL's”) 83.

Namely, FIG. 4 shows another exemplary configuration of the m×m MUX/DMUX section, in the SW network of the embodiment 1-2.

Each OC 81 is provided with first, second and third ports, such that the light input to the first port is output to the second port, and the light input to the second port is output to the third port.

The m·m numbers of OC's 81 are arranged in an array shape of m rows by m columns. Connected to the second port of each OC 81 is the associated FBG 82 with the other end thereof connected to the first port of the adjacent OC 81 within the same row. A third port of OC's 81 is connected to an input side of the m×1 CPL 83 for each column,

The centers of reflecting wavelength bands of FBG's 82 are set at sequentially from λ1 to λm in a first row, sequentially from λ2 to λm and λ1 in a second row, sequentially from λ3 to λm, λ1 and λ2 in a third row. Thereafter, the reflecting wavelength bands of FBG's 82 in the. respective rows are set in the same manner as the above. Namely, the centers of reflecting wavelength bands of FBG's 82 in each row are sequentially set from the wavelength corresponding to the row number such that λ1 cyclically comes next to λm, and so on.

In the m×m MUX/DMUX section having the above constitution, the relationships between inputs and outputs are such that the output ports are cyclically selected corresponding to the positions of the input ports and to the wavelengths of input lights, as shown in FIG. 3B.

For example, the light of the wavelength λ2 input to the input port 1 is input to a first port of an OC 81-11, then passed through a second port of an OC 81-11, a FBG 82-11, a first port of an OC 81-12 and a second port of the OC 81-12, and then input to a FBG 82-12 to be reflected by the FBG 82-12. The reflected light is again input to the second port of the OC 81-12, then passed through a third port of the OC 81-12 and a-CPL 83-2, and finally output from an output port 2 of the m×m MUX/DMUX section.

The m×m MUX/DMUX section 53 having such a constitution is also to control the input lights by utilizing optical characteristics and structures, so that the directional paths of input lights can be switched within the time lengths required by the input lights for being propagated through the optical paths, respectively. This enables to switch the directional paths of input lights in an extremely short period of time.

The configuration of the variable wavelength conversion section 51 will be described hereinafter.

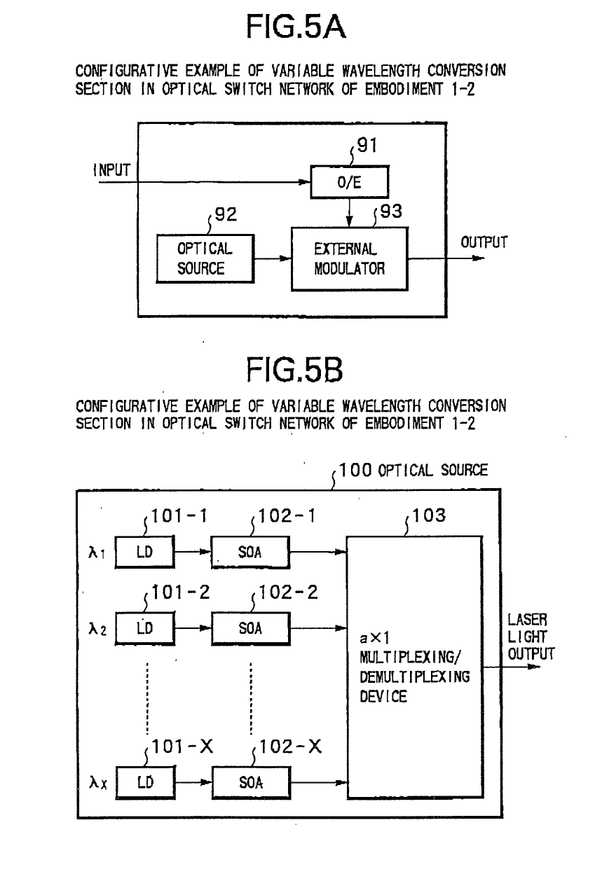

FIG. 5 is a diagram showing a configuration of the variable wavelength conversion section in the optical SW network of the embodiment 1-2.

The variable wavelength conversion section 51 is constituted of an O/E-E/O conversion.

In FIG. 5A, an input optical signal is input to an O/E 91 and photoelectrically converted from the optical signal into an electrical signal. Meanwhile, laser light emitted from a light source 92 is input to an external modulator 93 such as a Mach-Zehnder interferometer type external modulator, and modulated corresponding to the electrical signal output from the O/E 91. For example, the O/E 91 can be constituted to comprise, for example, a photodiode for receiving the input light, a synchronizing circuit for extracting a synchronization signal from the output of the photodiode, and a discriminator circuit for discriminating a signal from the output of the photodiode based on the synchronization signal.

The variable wavelength conversion section 51 having such a constitution is possible to output an optical signal of a desired wavelength converted from the wavelength of the input optical signal, by utilizing, as the light source 92, a light source capable of making the wavelength of laser light variable.

From the standpoint to stabilize the wavelength of the laser light input to the external modulator 93, it is preferable to provide a wavelength locker between the light source 92 and external modulator 93.

For example, it is possible to adopt a wavelength tunable semiconductor laser of a distributed feedback type or a distributed Bragg reflecting type, as the light source 92. Further, it is possible to adopt a light source 100 having a constitution shown in FIG. 5B.

The configuration of the light source 100 will be now described.

In FIG. 5B, the light source 100 is constituted to comprise plural x numbers of laser diodes (hereinafter abbreviated to “LD's”) 101 having mutually different wavelengths, x numbers of semiconductor optical amplifiers (hereinafter abbreviated to “SOA's”) 102 equal to the number of LD's 101, and an x×1 multiplexing/demultiplexing device 103, Each LD 101 is connected to the x×1 multiplexing/demultiplexing device 103 via associated SOA 102.

The light source 100 is possible to emit a laser light of a desired wavelength from the x×1 multiplexing/demultiplexing device 103, by driving the SOA 102 connected to the LD 101 which is to emit the laser fight of the desired wavelength. The laser light of the desired wavelength is optically amplified by the SOA 102, and then emitted. As the multiplexing/demultiplexing device 103, it is possible to adopt a multilayered dielectric film filter or an AWG, for example.

The functions and effects of the embodiment 1-2 will be described hereinafter, The optical signal of the wavelength λa is input to an input port b of a y-th group.

The control circuit identifies the y-th group and the input port b, into which the optical signal is input. The control circuit reads routing information indicating the directional path of this optical signal, to thereby identify the output port c of a z-th group which is to output this optical signal.

The above identification is conducted in the same manner as the embodiment 1-1. The control circuit thus is possible not only to receive the routing information, but also to identify the y-th group and the input port b based on the optical receiver from which the routing information has been received.

The control circuit determines the 1×p SW 52, m×m MUX/DMUX section 53 and p×1 SW 54, for connecting the input side y-th group to the output side z-th group. The control circuit switches the 1×p SW 52 connected with the input port b of the y-th group via a variable wavelength conversion section 51-yb such that the 1×p SW 52 is connected to the m×m MUX/DMUX section 53 with the respective outputs thereof being connected to the p×1 SW's 54 of the z-th group. The control circuit further switches the p×1 SW 54 so as to be connected to the output port c of the z-th group.

Then the control circuit refers to the wavelength-dependency input/output correspondence table stored in the storage circuit, to thereby determine the wavelength λd to be input to the input of the m×m MUX/DMUX section 53 connected with the input port b of the y-th group via the variable wavelength conversion section 51-yb, based on the input port b of the y-th group and the output port c of the z-th group.

The control circuit outputs, to the variable wavelength conversion section 51-yb connected to the input port b of the y-th group, a control signal for converting the wavelength of the optical signal into the wavelength λd.

Then, the variable wavelength conversion section 51-yb converts the wavelength of the optical signal from the wavelength λa into the wavelength λd based on the control signal, and outputs the thus converted optical signal to the m×m MUX/DMUX section 53.

The optical signal is input to the m×m MUX/DMUX section 53, wherein the directional path of the optical signal is changed, and output from the output connected to the output port c of the z-th group via the p×1 SW 54.

There will be more concretely described a situation where the optical signal of the wavelength λ3 input to the input port 1 of the second group is output to the output port 2 of the first group, for example.

The control circuit identifies the second group and the input port 1 thereof, to which the optical signal is input. The control circuit reads routing information indicating the directional path of this optical signal, to thereby identify the output port 2 of the first group which is to output this optical signal.

The control circuit then determines the 1×p SW 52-211, m×m MUX/DMUX section 53-21, and p×1 SW 54-12, for connecting the input port 1 of the input side second group to the output port 2 of the output side first group. The control circuit switches the 1×p SW 52-21 so as to be connected to the m×m MUX/DMUX section 53-21. The control circuit switches the p×1 SW 54-12 so as to be connected to the output port 2 of the output side first group. The control circuit then refers to the wavelength-dependency input/output correspondence table stored in the storage circuit, to thereby determine the wavelength λ2 to be input to the input of the m×m MUX/DMUX section 53-21, based on the position of the input port 1 of the input side second group and based on the position of the output port 2 of the output side first group.

The control circuit outputs, to the variable wavelength conversion section 51-21, to command the part 51-21, a control signal for converting the wavelength of the optical signal into the wavelength λ2. The variable wavelength conversion section 51-21 converts the wavelength of the optical signal from the wavelength λ3 into the wavelength λ2 based on the control signal, and outputs the converted optical signal-to the m×m MUX/DMUX section 53-21 via the 1×p SW 52-21.

The optical signal is input to the input port 1 of the m×m MUX/DMUX section 53-21 and output from the output part 2 of the section 53-21, and thereafter output from the output port 2 of the output side first group via the p×1 SW 54-12.

There will be now briefly described a situation where the optical signal of wavelength λ5 input to an input port 2 of the fourth group is to be output to the output port 3 of the second group, for example. The wavelength of optical signal is converted from the wavelength λ5 into the wavelength λ4 at a variable wavelength conversion section 51-42 based on the control signal, and output from the output port 3 of the second group via 1×p SW 52-42, m×m MUX/DMUX section 53-42 and p×1 SW 54-23.

Further, there will be briefly described a situation where the optical signal of wavelength λ5 input to an input port 3 of the seventh group is to be output to an output port 10 of the third group, for example. The wavelength of optical signal is converted from the wavelength λ5 into the wavelength λ14 at a variable wavelength conversion section 51-75 based on the control signal, and output from the output port 10 of the third group via 1×p SW 52-75, m×m MUX/DMUX section 53-75 and p×1 SW 54-310.

In the above, there has been described each situation where the single optical signal is individually input. However, the m'm MUX/DMUX sections 53 are capable of simultaneously changing the routes of a plurality of optical signals even when the optical signals are simultaneously input. Thus, the control circuit controls the respective wavelengths of plurality of optical signals, respectively, so that directional paths of the plurality of optical signals can be simultaneously changed. In this way, the n×n optical SW network in the embodiment 1-2 is a fully nonobstructive optical SW network capable of outputting those optical signals input to input ports from predetermined output ports, respectively. Further, the optical SW network in the embodiment 1-2 can be regarded as a space sharing equivalent structure.

In the above description of the functions and effects, the relationships are 1≦a, d, e, hem; 1≦b, c, f, g≦n; 1≦y; and z≦p.

From the standpoint that the wavelength of the optical signal to be output from the output port is to be reconstructed into a predetermined wavelength, in the n×n optical SW network of the embodiment 1-2, it is preferable to provide a fixed wavelength conversion section between each p×1 SW 54 and the associated output port. Particularly, in each group, it is possible to obtain an output of a WDM optical signal, by rendering predetermined wavelengths to correspond to the wavelengths of optical signals included in the WDM optical signal, and by wavelength division multiplexing the optical signals emitted from the output ports into the WDM optical signal. The aforementioned fixed wavelength conversion section can be constituted by substituting the light source 92 by a light source oscillating a predetermined single wavelength, for the variable wavelength conversion section 51 shown in FIG. 5A. As such a light source, it is possible to utilize various semiconductor lasers including Fabry-Perot type, distributed feedback type, distributed Bragg reflecting type.

Note, the p×1 SW 54 may be a p×1 CPL in the embodiment 1-2.

An embodiment 1-3 of the present invention will be described hereinafter.

This embodiment 1-3 is a D×D optical SW network aiming at constructing a large-scale optical SW network for further increasing input and output ports compared to the n×n optical SW network of the embodiment 1-2.

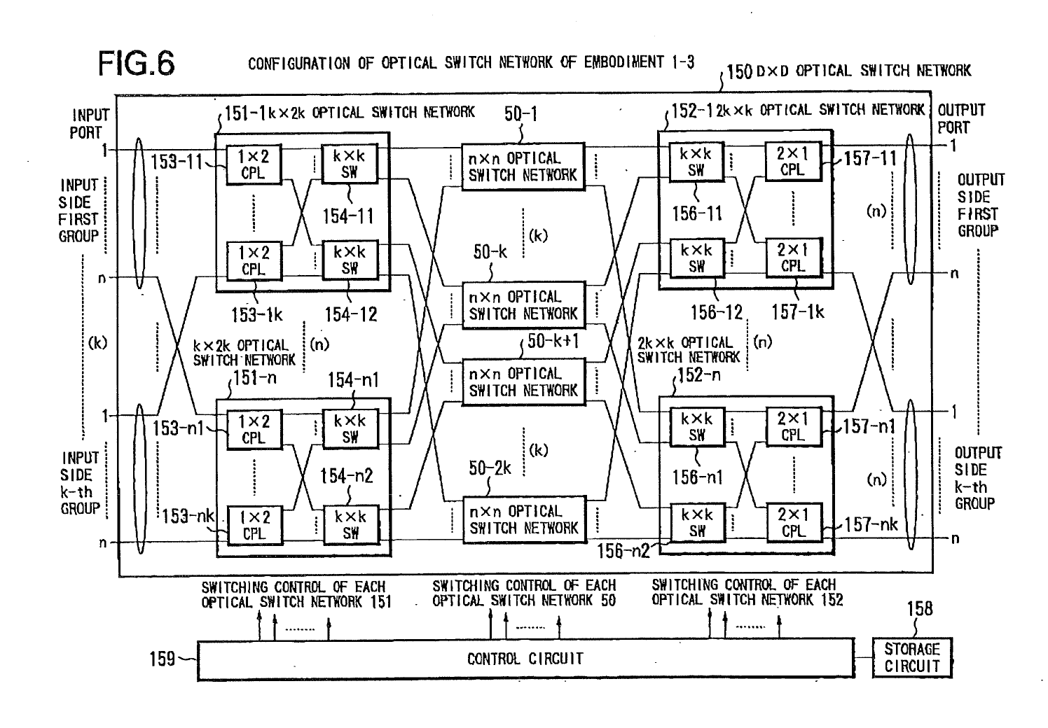

FIG. 6 is a diagram showing a configuration of the optical SW network of the embodiment 1-3.

This D×D optical SW network 150 is constituted of a three-stage optical SW network comprising D numbers of input ports, n numbers of k×2k optical SW networks 151, 2k numbers of n×n optical SW networks 50, n numbers of 2k×k optical SW networks 152 and D numbers of output ports.

Here, D and k are positive integers, respectively, and satisfy the relationship represented by the following equation (5):

D=n·k (5).

In FIG. 6, the D numbers of input ports are divided into k groups, while treating n numbers as one bundle. In each group, the n numbers of input ports are connected to the n numbers of k×2k optical SW networks 151, respectively, in a one-to-one manner.

Each k×2k optical SW network 151 is constituted to comprise k numbers of 1×2 CPL's 153 and two numbers of k×k SW's 154. Two outputs of each 1×2 CPL 153 are connected to the two numbers of k×k SW's 154, respectively, in a one-to-one manner.

In each k×2k optical SW network 151, k numbers of outputs of the one k×k SW 154 are connected to k numbers of n×n optical SW networks 50-1 to 50-k, respectively, in a one-to-one manner; and k numbers of outputs of the other k×k SW 154 are connected to k numbers of n×n optical SW networks 50-k+1 to 50-2k, respectively, in a one-to-one manner. This n×n optical SW network 50 is the one described in the embodiment 1-2.

In each n×n optical SW network 50, n numbers of outputs are connected to the n numbers of 2k×k optical SW networks 152, respectively, in a one-to-one manner.

Each 2k×k optical SW network 152 is constituted to comprise two numbers of k×k SW's 156 and k numbers of 2×1 CPL's 157. In each k×k SW 156, k numbers of outputs thereof are connected to k numbers of 2×1 CPL's 157, respectively, in a one-to-one manner.

The D numbers of output ports are divided into k groups, while treating n numbers as one bundle.

In each of the n numbers of 2k×k optical SW networks 152, k numbers of outputs thereof are connected to output ports in the k numbers of group in a one-to-one manner.

A storage circuit 158 stores such as a wavelength-dependency input/output correspondence table showing corresponding relationships between input positions and wavelengths of input lights, and output positions, in the m×m MUX/D MUX sections of n×n optical SW networks 50, and a relationship table, for connecting the input ports and output ports, showing corresponding relationships among the variable wavelength conversion sections, 1×p SW's, m×m MUX/DMUX sections and p×1 SW's. A control circuit 159 is connected to the storage circuit 158, for controlling the k×2k optical SW networks 151, the 2k×k optical SW networks 152 and the variable wavelength conversion sections, 1×p SW's, m×m MUX/DMUX sections and p×1 SW's in each n×n optical SW network 50, by referring to the respective tables.

The D×D optical SW network in the embodiment 1-3 has a configuration equivalent to a three-stage close type optical SW network.

There will be now described the functions and effects of the embodiment 1-3.

The optical signal of the wavelength λa is input to an input port b of a y-th group.

The control circuit 159 identifies the y-th group and the input port b, into which this optical signal is input. The control circuit 159 reads routing information indicating the directional path of this optical signal, to thereby identify an output port c of a z-th group which is to output this optical signal.

The control circuit 159 determines the k×2k optical SW network 151, the n×n optical SW network 50 and the 2k×k optical SW network 152, for connecting the input side y-th group to the output side z-th group. The control circuit 159 switches the k×2k optical SW network 151 connected with the input port b of the y-th group such that the k×2k optical SW network 151 is connected to the n×n optical SW network 50 which has a directional path connected to the output port c of the z-th group. The control circuit 159 further switches the 2k×k optical SW network 152 so as to connect to the output port c of the z-th group.

There shall be omitted the description of the functions and effects within the n×n optical SW network 50 for switching the 1×p SW, for switching the p×1 SW and for converting the wavelength of the optical signal at the variable wavelength conversion section, because such functions and effects are the same with those in the embodiment 1-2.

The optical signal is input to the n×n optical SW network 50 via the k×2k optical SW network 151, and the directional path of the optical signal is changed corresponding to the wavelength-dependency input/output relationships, such that the optical signal is output from the output connected to the output port c of the z-th group via the 2k×k optical SW network 152,

There will be more specifically described a situation where the optical signal of the wavelength λ3 input to the input port 3 of the input side first group is output to the output port 2 of the output side fourth group, for example.

The control circuit 159 identifies the input port 3 of the first group, to which the optical signal is input. The control circuit 159 reads routing information indicating the directional path of this optical signal, to thereby identify the output port 2 of the fourth group which is to output this optical signal.

The control circuit 159 then determines a k×2k optical SW network 151-1, a n×n optical SW network 50-4 and a 2k×k optical SW network 152-4f for connecting the input port 3 of the input side first group to the output port 2 of the output side fourth group.

In the k×2k optical SW network 151-1, the route of the optical signal includes a 1×2 CPL 153-13 and a k×k SW 154-11.

In the 2k×k optical SW network 152-4, the route of the optical signal includes a k×k SW 156-41 and a 2×1 CPL 157-43.

In the n×n optical SW network 50-4, the m×m MUX/DMUX section converts the wavelength of optical signal input to the input port 3 from the wavelength λ3 into the wavelength λ6 to be output from the output port 4.

In this way, the optical signal is output from the desired output port of the desired group.

Further, the m×m MUX/DMUX sections in the n×n optical SW network 50 are capable of simultaneously changing the routes of a plurality of optical signals even when the optical signals are simultaneously input. Thus, the control circuit 159 controls the respective wavelengths of the plurality of optical signals, so that directional paths of the plurality of optical signals are simultaneously changed. In this way, the D×D optical SW network 150 in the embodiment 1-3 is a fully nonobstructive optical SW network capable of outputting the optical signals input to input ports from predetermined output ports, respectively.

In the above description of the functions and effects, the relationships are 1≦a, d≦m; 1≦b, c≦n; and 1≦y, z≦k.

Next, an embodiment 1-4 of the present invention will be now described.

This embodiment 1-4 is an embodiment of a D×D optical SW network aiming at constructing a large-scale optical SW network.

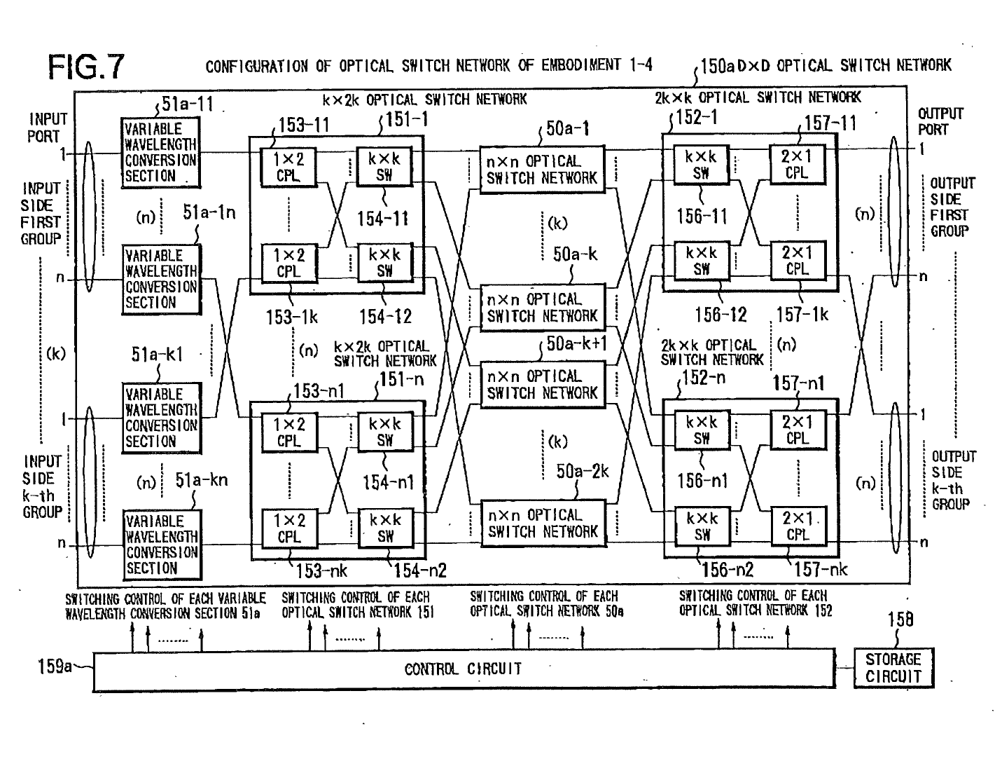

FIG. 7 is a diagram showing a configuration of the optical SW network of the embodiment 1-4.

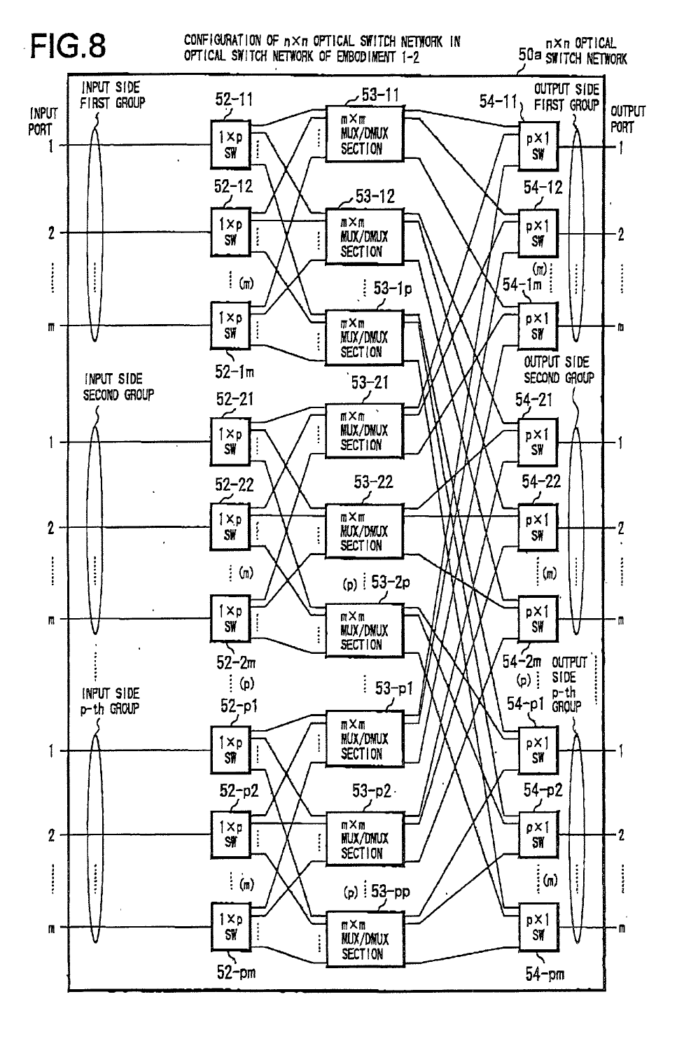

FIG. 8 is a diagram showing a configuration of an n×n optical SW network in the D×D optical SW network of the embodiment 1-4.

Although the D×D optical SW network 150 of the above embodiment 1-3 has been provided with the variable wavelength conversion sections 51 within the n×n optical SW networks 50, a D×D optical SW network 150a of the embodiment 1-4 is provided with such variable wavelength conversion sections 51 between D numbers of input ports and n numbers of k×2k optical SW networks 151, such that the n×n optical SW networks 50 are substituted by n×n optical SW networks 50a shown in FIG. 8.

Thus, in the configuration of the D×D optical SW network 150a of the embodiment 1-4 shown in FIG. 7, the D numbers of input ports are divided into k groups, while treating n numbers as one bundle. In each group, the n numbers of input ports are connected to the n numbers of k×2k optical SW networks 151, respectively, in a one-to-one manner. There shall be omitted the description of the configurations of the k×2k optical SW networks 151 and so forth in the D×D optical SW network of the embodiment 1-4, since such configurations are the same with those in the D×D optical SW network of the embodiment 1-3, except that the embodiment 1-4 adopts the n×n optical SW networks 50a.

As shown in FIG. 8, the configuration of each n×n optical SW network 50a is such that the variable wavelength conversion sections 51 in the n×n optical SW network 50 shown in FIG. 2 are omitted, and n numbers of input ports are directly connected to the n numbers of 1×p SW's 52, respectively the description of the configurations of the 1×p SW's 52 and so forth shall be omitted, since such configurations are the same with those in the n×n optical SW network 50 shown in FIG. 2.

Further, the description of the functions and effects of the D×D optical SW network of the embodiment 1-4 shall be omitted, since such functions and effects are the same with those of the embodiment 1-3.

By virtue of such configuration of the embodiment 1-4, the number of variable wavelength conversion sections 51 in the embodiment 1-4 can be reduced to the half of the embodiment 1-3, i.e., from 2·k·n numbers (embodiment 1-3) to k·n numbers (embodiment 1-4).

Thus, the embodiment 1-4 is possible to realize further downsize and a lower cost of the optical SW network, as compared with the embodiment 1-3.

From the standpoint that the wavelength of the optical signal to be output from the output port is to be reconstructed into a predetermined wavelength, it is preferable to provide a fixed wavelength conversion section between each 2k×k optical SW network 152 and the associated output port, in the D×D optical SW networks 150, 150a of the embodiment 1-3 and embodiment 1-4.

An embodiment 1-5 of the present invention will be described hereinafter.

The embodiment 1-5 is an embodiment of an optical cross connecting device (hereinafter abbreviated to “optical XC”).

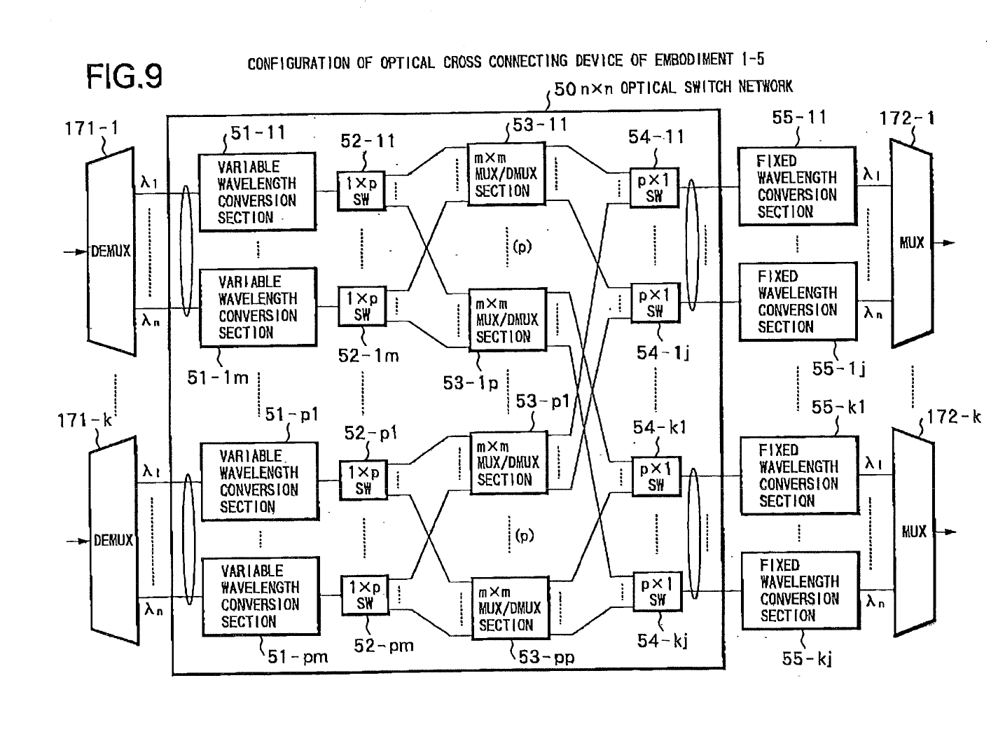

FIG. 9 is a diagram showing a configuration of the optical cross connecting device of the embodiment 1-5.

In FIG. 9, k numbers of optical transmission paths such as optical fibers are connected to k numbers of optical demultiplexers (hereinafter abbreviated to “DEMUX's”), respectively,

Each DEMUX 171 is an optical element for separating an input WDM optical signal for each wavelength.

Outpus of each DEMUX 171 are, as one group, connected to input ports of each group in the n×n optical SW network 50, respectively. The description of the n×n optical SW network 50 shall be omitted, since it is the same as the embodiment 1-2 shown in FIG. 2.

The storage circuit (not shown) stores therein, for example: a wavelength-dependency input/output correspondence table for the MUX/DMUX sections in the n×n optical SW network 50 and a relationship table, for connecting the input ports and output ports, showing corresponding relationships among the variable wavelength conversion sections 51, 1×p SW's 52, m×m MUX/DMUX sections 53 and p×1 SW's 54. The control circuit (not shown) is connected to the storage circuit to thereby control the variable wavelength conversion sections 51, 1×p SW's 52, m×m MUX/DMUX sections 53 and p×1 SW's 54, by referring to the respective tables.

The outputs of the n×n optical SW network 50 are connected via fixed wavelength conversion sections 55, to k numbers of optical multiplexers (hereinafter abbreviated to “MUX's”) 172 for each group.

Each fixed wavelength conversion section 55 is to convert an input optical signal into a predetermined single wavelength, and can be constituted by substituting the light source 92 by a light source oscillating the predetermined single wavelength, with respect to the variable wavelength conversion section 51 shown in FIG. 5A. Further, the predetermined wavelengths of fixed wavelength conversion sections 55 are set such that each MUX 172 is input with optical signals corresponding to the wavelengths in the WDM optical signal,

Each MUX 172 is an optical element for wavelength division multiplexing the lights input to the MUX 172. As the DEMUX's 171 and MUX's 172, it is possible to adopt multilayered dielectric film filters, AWG's, or the like.

The functions and effects of the embodiment 1-5 will be described hereinafter.

The n-wave WDM optical signal transmitted through a xi-th optical transmission path is input to a DEMUX 171-xi, Note, the n-wave WDM optical signal comprises wavelength division multiplexed plural m. numbers of optical signals of mutually different wavelengths,

The n-wave WDM optical signal is wavelength-separated into n numbers of optical signals by the DEMUX 171-xi, and these optical signals as a xi-th group are then input to the n×n optical SW network 50.

The description of the way to change directional paths in the n×n optical SW network 50 shall be omitted, since it is the same as the embodiment 1-2.

The optical signals output from a xo-th group of the n×n optical SW network 50 are converted into predetermined wavelengths by the fixed wavelength conversion sections 55, then input to the MUX 172-xo, and then brought back to the n-wave WDM optical signal to be transmitted to a xo-th optical transmission path. Since the WDM optical signal is n-wave multiplexed, the predetermined single wavelength at the n numbers of fixed wavelength conversion sections 55 connected to one MUX 172 is assigned with any one of wavelengths λ1 to λm such that none of wavelengths λ1 to λm is overlappedly used.

In the optical XC of the aforementioned embodiment 1-5, the WDM optical signal input from an arbitrary optical transmission path can be output to an arbitrary MUX 172, by changing the directional paths of respective optical signals by means of the n×n optical SW network 50. In turn, each MUX 172 is possible to wavelength division multiplex the optical signal included in the WDM optical signal input from one optical transmission path and the optical signal included in the WDM optical signal input from another optical transmission path again into a WDM optical signal.

Namely, in the optical XC of the embodiment 1-5, it is possible to output an optical signal included in a WDM optical signal input from an arbitrary optical transmission path to an arbitrary optical transmission path.

In the embodiment 1-5, there has been mentioned the m numbers as the number of wavelengths which can be dealt with by the m×k. numbers of optical transmission paths and by the MUX/DMUX sections in the n×n optical SW network 50. However, the number of wavelengths to be dealt with by the MUX/DMUX sections can be reduced to v numbers which is smaller than the m numbers by constituting the n×n optical SW network 5P into v numbers×q groups (v and q are positive integers) while keeping m·k=v·q.

Further, in the optical XC of the embodiment 1-5, there has been adopted the n×n optical SW network 50 of the embodiment 1-2. However, it is also possible to adopt the D×D optical SW network 150 of the embodiment 1-3 shown in FIG. 6, or the D×D optical SW network 150a of the embodiment 1-4 shown in FIG. 7. Thereby, it is possible to realize a large-scale optical XC.

An embodiment 1-6 of the present invention will be described hereinafter.

The embodiment 1-6 is an embodiment of an optical cross connecting device for switching lines of WDM optical signals ranging over a plurality of wavelength bands.

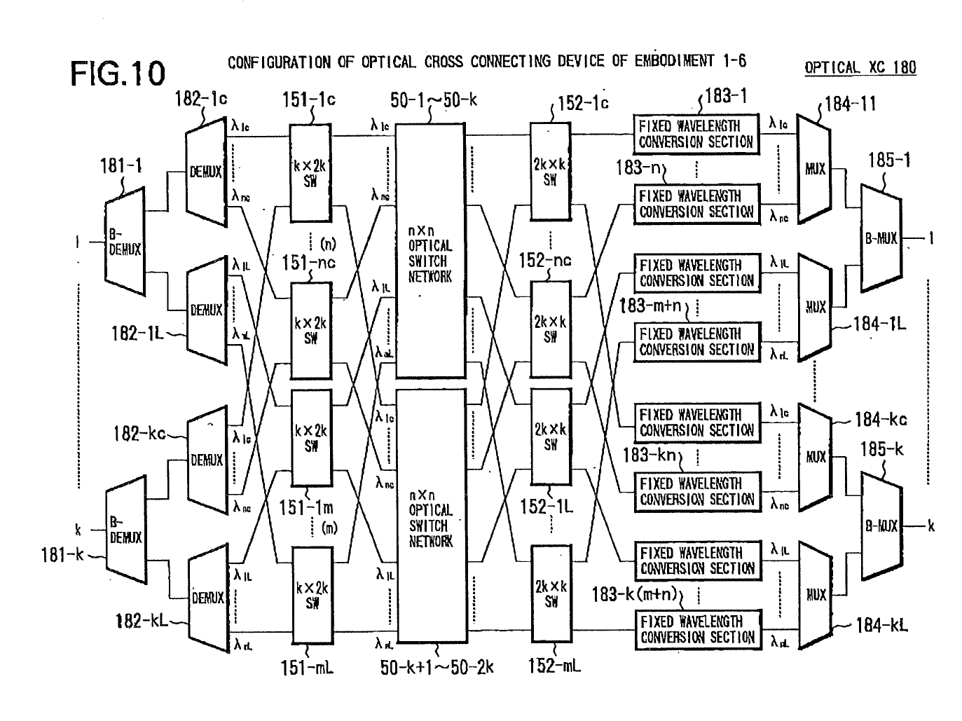

FIG. 10 is a diagram showing a configuration of the optical cross connecting device of the embodiment 1-6.

In FIG. 10, k numbers of optical transmission paths are connected to k numbers of band optical demultiplexers (hereinafter abbreviated to “B-DEMUX”) 181, respectively.

Each B-DEMUX 181 is an optical element for separating the input WDM optical signal ranging over a plurality of wavelength bands, for each the wavelength band (or for each band), respectively.

The outputs of each B-DEMUX 181 are connected to DEMUX's 182 provided for the respective bands. Each DEMUX 182 further separates the WDM optical signal separated for each band into optical signals corresponding to respective wavelengths. The group of optical signals separated at the DEMUX 182 corresponds to each group of optical signals at the input side in the embodiment 1-3.

There shall be omitted the description of the configurations of the k×2k optical SW networks 151, n×n optical SW networks 50 and 2k×k optical SW networks 152, since such configurations are the same as those in the embodiment 1-3 shown in FIG. 6.

The storage circuit (not shown) stores therein, for example a wavelength-dependency input/output correspondence table for the MUX/DMUX sections in the n×n optical SW networks 50 and a relationship table, for connecting the input ports and output ports, showing corresponding relationships among the variable wavelength conversion sections, 1×p SW's, m×m MUX/DMUX sections and p×1 SW's. The control circuit (not shown) is connected to the storage circuit to thereby control the variable wavelength conversion sections, 1×p SW's, m×m MUX/DMUX sections and p×1 SW's, by referring to the respective tables.

Outputs of the 2k×k optical SW networks 152 are connected to MUX's 184 via fixed wavelength conversion sections 183, respectively, for each band,

Each fixed wavelength conversion section 183 converts an input optical signal into a predetermined single wavelength. In each fixed wavelength conversion sections 183, a wavelenth thereof is set such that the single MUX 184 is input with optical signals corresponding to the optical signals in the applicable band.

Each MUX 184 is wavelength division multiplexes the optical signals input thereto, to thereby generate the WDM optical signal in the applicable band. The WDM optical signals generated at MUX's 184 in the different bands are input to k numbers of band optical multiplexers (hereinafter abbreviated to “B-MUX's”) 185, respectively, and again multiplexed into WDM optical signals ranging over the plurality of wavelength bands to be transmitted to optical transmission paths. As the B-DEMUX's and B-MUX's, it is possible to utilize multilayered dielectric film filters, for example.

The functions and effects of the embodiment 1-6 will be described hereinafter.

In optical networks, there are utilized a plurality of wavelength bands for transmitting optical signals, such as an S+band (1450 nm to 1490 nm), S band (1490 nm to 1530 nm), C band (1530 nm to 1570 nm), L band (1570 nm to 1610 nm), and L+band (1610 nm to 1650 nm).

The WDM optical signals ranging over a plurality of wavelength bands are multiplexed with n numbers of waves in the C band and with m numbers of waves in the L band, for example.

This WDM optical signal of (n+m) waves transmitted through a xi-th optical transmission path is input to a B-DEMUX 181-xi, and separated for each wavelength band into two WDM optical signals in the C band and L band. These two WDM optical signals are input to a DEMUX 182-xic and a DEMUX 182-xiL, respectively.

The WDM optical signal in the C band is wavelength-separated into n numbers of optical signals by the DEMUX 182-xic, and these optical signals as a xic-th group are input to the n×n optical SW networks 50.

Similarly, the WDM optical signal in the L band is wavelength-separated into m numbers of optical signals by the DEMUX 182-xiL, and these optical signals as a xiL-th group are input to the n×n optical SW networks 50.

There shall be omitted the description of the way to change directional paths in each n×n optical SW network 50, since it is the same as the embodiment 1-2.

The optical signals output from a xoc-th group of the n×n optical SW networks 50 are converted into predetermined wavelengths in the C band by the fixed wavelength conversion sections 183, then input to a MUX 184-xoc, and thereby brought back to the n-wave WDM optical signal in the C band to be transmitted to a B-MUX 185-xo.

Similarly, the optical signals output from a xoL-th group of the n×n optical SW networks 50 are converted into predetermined wavelengths in the L band by the fixed wavelength conversion sections 183, then input to a MUX 184-xoL, and thereby brought back to the m-wave WDM optical signal in the L band to be transmitted to the B-MUX 185-xo.

The B-MUX 185-xo wavelength division multiplexes these WDM optical signals into a WDM optical signal of (n+m) waves, and transmits the WDM optical signal to a xo-th optical transmission path.

In the optical XC of the aforementioned embodiment 1-6, any WDM optical signal ranging over a plurality of wavelength bands input from an arbitrary optical transmission path can be output to an arbitrary optical transmission path, by changing the directional paths of respective optical signals by means of the n×n optical SW networks 50, similarly to the embodiment 1-5.

In the embodiment 1-6, there has been utilized the optical SW network of the embodiment 1-3 shown in FIG. 6. However, it is also possible to utilize the optical SW networks shown in the embodiment 1-2 and embodiment 1-4.

An embodiment 1-7 of the present invention will be described hereinafter.

The embodiment 1-7 is an embodiment of an optical cross connecting device for switching lines of WDM signal ranging over a wide band.

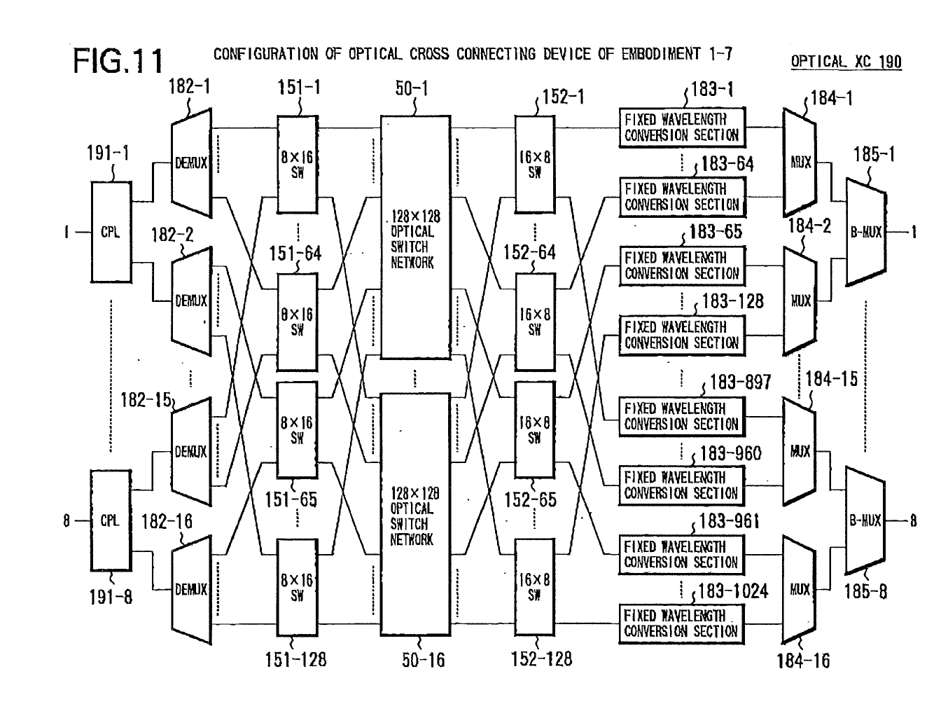

FIG. 11 is a diagram showing a configuration of the optical-cross connecting device of the embodiment 1-7.

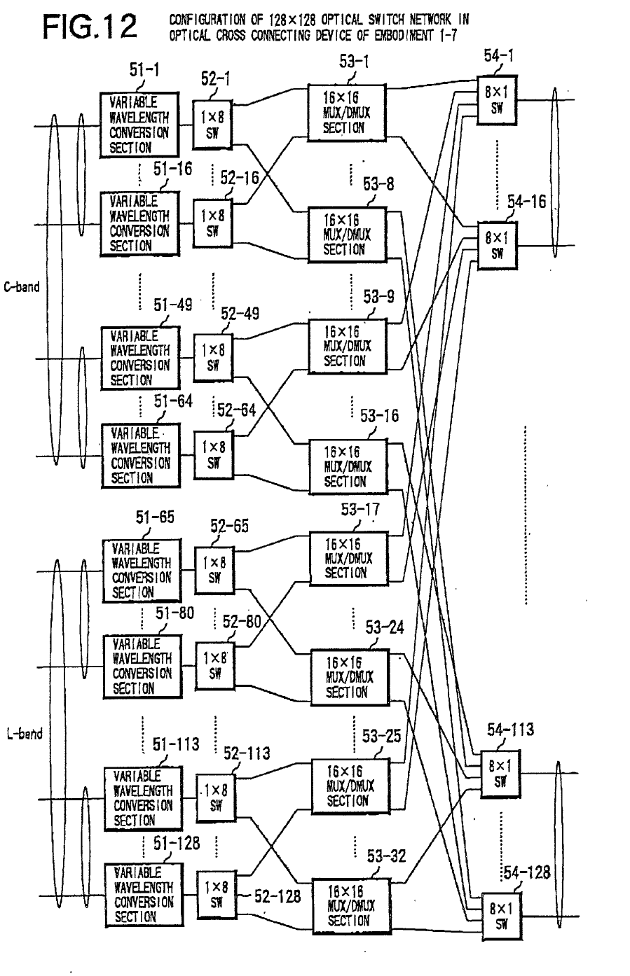

FIG. 12 is a diagram showing a configuration of a 128×128 optical SW network in the optical cross connecting device of the embodiment 1-7.

In FIG. 11, there shall be omitted the description of an optical XC 190, since the configuration thereof is the same as the optical XC 180 of the embodiment 1-6 shown in FIG. 10, except that B-DEMUX's 181 in the embodiment 1-6 are substituted by CPL's 191.

In such an optical XC 190, the wide-band WDM optical signal ranging over a plurality of wavelength bands is branched, by each CPL 191, to WDM optical signals of the number corresponding to the number of the associated DEMUX's 182, The thus branched wide-band WDM optical signals are input to the associated DEMUX's 182, respectively, and separated for each wavelength.

Generally, each DEMUX 182 separates a plurality of wavelengths only in the predetermined wavelength band for each wavelength. Thus, even when the wide-band WDM optical signal is input to the DEMUX 162, the optical signals wavelength-separated and emitted from the DEMUX 182 are the same as those in the embodiment 1-6.

Note, FIG. 11 shows a configuration of the optical XC where the WDM optical signal includes two wavelength bands,

Further, FIG. 12 shows a configuration where m=16 and p=8 in FIG. 2, so the description thereof shall be omitted.

Thus, there shall be omitted the description of the functions and effects of the DEMUX 182 and so forth of the optical XC 190, since it is the same as the embodiment 1-6.

According to the optical XC 190 having such a configuration, it is. possible to change directional paths for each of respective optical signals included in a WDM optical signal ranging over two wavelength bands including 128 waves, in which for example, the C band is wavelength division multiplexed with 64 waves of wavelengths λ1 to λ64 and the L band is wavelength division multiplexed with 64 waves of wavelengths λ65 to λ128.

According to the optical XC 190 having such a configuration, it is possible to cope with such a situation where the number of wavelength bands in the wide-band WDM optical signal is increased, by simply adding an additional DEMUX 182 and corresponding components. In the embodiment 1-6, it has been required to change the B-DEMUX's 181 corresponding to the added wavelength band. Thus, the optical XC of the embodiment 1-7 is advantageous in this point.

For example, it is now supposed that there shall be newly added an S band WDM optical signal to the optical XC for two-band WDM optical signal of C band and L band to thereby modify the WDM optical signal into a three-band WDM optical signal. In this situation, it is enough to additionally provide a DEMUX 182 and corresponding components for the S bard for each CPL 191, and to render the CPL 191 to branch the three-band WDM optical signal into the DEMUX 182-1 for the C band, into the DEMUX 182-2 for the L band, and into the added DEMUX 182 for the S band.

An embodiment 1-8 of the present invention will be now described.

The embodiment 1-8 is an embodiment of an optical cross connecting device.

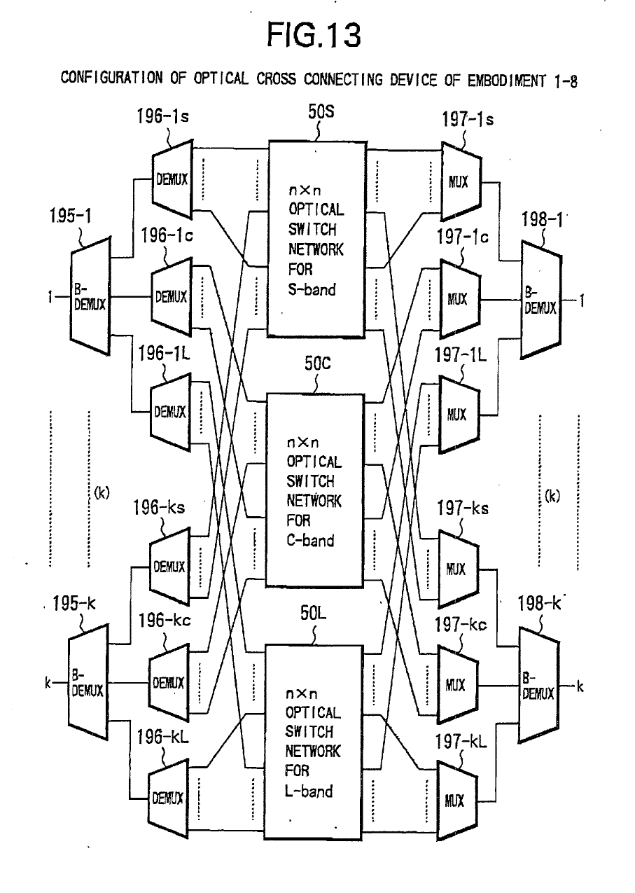

FIG. 13 is a diagram showing a configuration of the optical cross connecting device of the embodiment 1-8.

Identically with the embodiments 1-6 and 1-7, the embodiment 1-8 is capable of changing directional paths of optical signals included in WPM optical signals ranging over a plurality of wavelength bands, However, differently from the embodiments 1-6 and 1-7, the embodiment 1-8 is capable of changing the directional paths in an independent manner for each wavelength band.

To realize it, the wide-band WDM optical signal is separated into WDM optical signals in the respective wavelength bands by a B-DEMUX 195, and the directional paths of optical signals included in these WDM optical signals in the respective wavelength bands are changed by optical SW networks 50 provided for the respective wavelength bands.

For example, the S-band WDM optical signals band-separated by the B-DEMUX's 195, respectively, are input to DEMUX's 196-is to 196-ks, respectively, wavelength-separated into optical signals by the DEMUX's 196-is to 196-ks, respectively, and then input to an S-band-aimed n×n optical SW network 50S. The C-band WDM optical signals band-separated by the B-DEMUX's 195, respectively, are input to DEMUX's 196-1c to 196-kc, respectively, wavelength-separated into optical signals by the DEMUX's 196-ic to 196-kc, respectively, and then input to a C-band-aimed n×n optical SW network 50C. The L-band WDM optical signals band-separated by the B-DEMUX's 195, respectively, are input to DEMUX's 196-1L to 196-kL, respectively, wavelength-separated into optical signals by the DEMUX's 196-IL to 196-kL, respectively, and then input to an L-band-aimed n×n optical SW network 50L.

The optical signals, the directional paths of which have been changed, are input to MUX's 197 for each band. The optical signals are again multiplexed into WDM optical signals of the respective bands by the MUX's 197, and then input to B-MUX's 198. The B-MUX's 198 multiplex the WDM optical signals into wide-band WDM optical signals ranging over a plurality of wavelength bands, respectively, to transmit to optical transmission paths, respectively.

For example, the S-band optical signals, the directional paths of which have been changed, are input from the S-band-aimed n×n optical SW network 50S into MUX's 197-is to 197-ks, and then input to B-MUX's 198, respectively. The C-band optical signals, the directional paths of which have been changed, are input from the C-band-aimed n×n optical SW network 50C into MUX's 197-ic to 197-kc, and then input to B-MUX's 198, respectively. The L-band optical signals, the directional paths of which have been changed, are input from the L-band-aimed n×n optical SW network 50L into MUX's 197-1L to 197-kL, and then input to B-MUX's 198, respectively. Each B-MUX 198 wavelength division multiplexes the WDM optical signals in the S, C or L bands, again into a WDM optical signal ranging over the three-bands, to transmit to the optical transmission path.

There shall be omitted the description of the functions and effects of the embodiment 1-8, since the embodiment 1-8 is different from the embodiments 1-6 and 1-7 only in that the directional paths of optical signals are independently changed for each wavelength band, as described above.

An embodiment 1-9 of the present invention will be described hereinafter.

This embodiment 1-9 is an embodiment of an optical network.

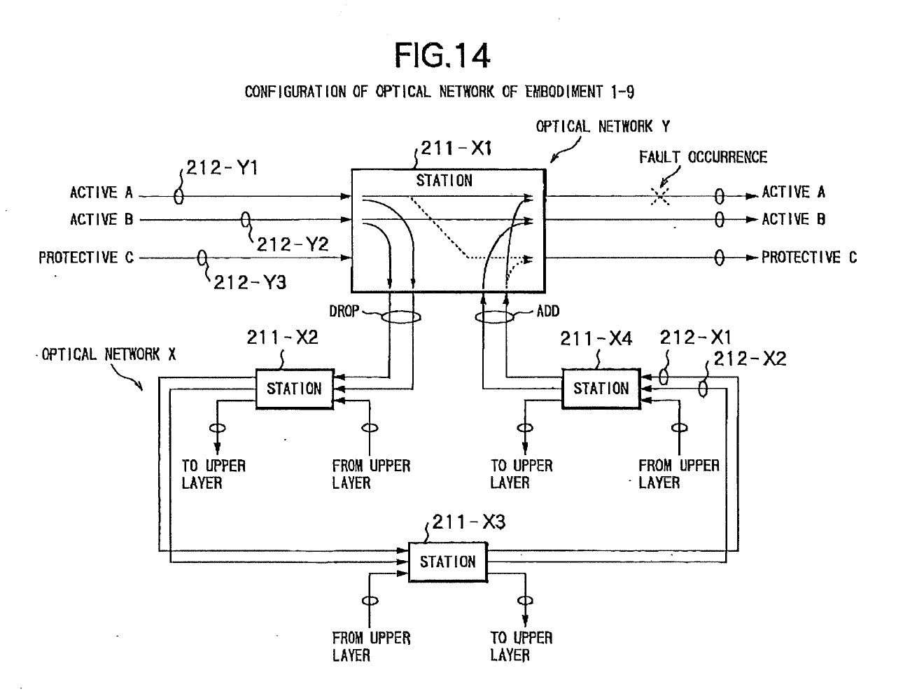

FIG. 14 is a diagram showing a configuration of the optical network of the embodiment 1-9.

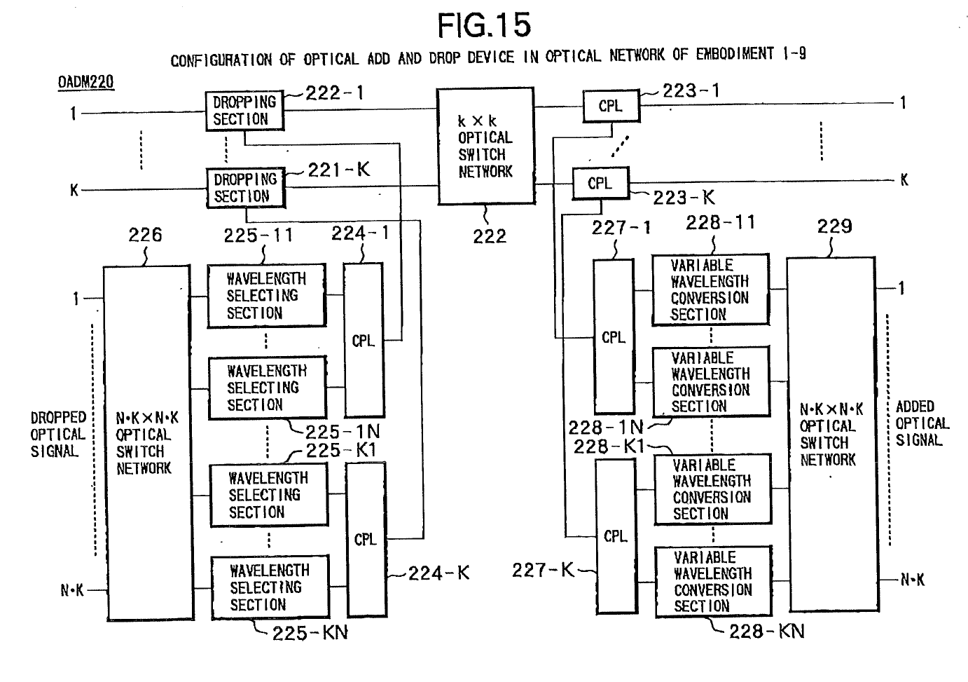

FIG. 15 is a diagram showing a configuration of an optical add/drop multiplexer in the optical network of the embodiment 1-9.

In FIG. 14, this optical network constitutes a ring-shaped network comprising a plurality of stations 211, each including an optical add/drop multiplexer (hereinafter abbreviated to “OADM”) for adding/dropping a predetermined optical signal from and to the WDM optical signal being transmitted within the network and a plurality of optical transmission paths 212 for connecting these stations 211.

FIG. 14 shows an optical network X and a part of an optical network Y. In the optical network X, the optical transmission paths 212 comprise two active optical transmission path groups 212-X1, 212-X2, and the stations 211 comprise four stations 211-X1, 211-X2, 211-X3 and 211-X4. In the optical network Y. the optical transmission paths 212 comprise two active A and B optical transmission path groups 212-Y1 and. 212-Y2, and one protective C optical transmission path group 212-Y3, and the station 211-X1 is provided as a station between the optical networks X and Y so as to add/drop optical signals.

In normal optical communications, WDM optical signals are transmitted in active optical transmission paths, and protective optical transmission paths are used if a fault occurred in the active optical transmission paths,

There will be described hereinafter the configuration of an OADM 220 provided in the station 211.

In FIG. 15, plural K numbers of dropping sections 221 (K is a positive integer) are connected to plural K numbers of optical transmission paths 212, respectively. The K numbers of optical transmission paths include 1 to k1 assigned to the active A, (k1+1) to k2 assigned to the active B, and (k2+1) to K assigned to the protective C.

Each dropping section 221 is a circuit for dropping an arbitrary number of optical signals of arbitrary wavelengths from the WDM optical signal being transmitted through the optical transmission path 212. As such a dropping section 221, it is possible to utilize an acoustooptic tunable filter (hereinafter abbreviated to “AOTF”).

Such an AOTF is constituted to comprise two numbers of optical waveguides formed in a substrate exhibiting a piezoelectric effect, polarization beam splitters provided at two crossing portions where the optical waveguides are crossed with each other at two points between input ends and exit ends of the optical waveguides, and electrodes for causing the two optical waveguides to generate surface acoustic waves (ultrasonic waves) between these crossing portions. The AOTF is a filter for inducing changes of refractive indexes of these optical waveguides based on the acoustooptic effect by the surface acoustic waves, so as to rotate the polarization states of the lights being propagated through the optical waveguides, to thereby separate/select a light of an arbitrary wavelength. The surface acoustic wave is generated by applying a voltage at an RF frequency to the electrodes. In dropping a plurality of optical signals of mutually different wavelengths by the AOTF, the electrodes are simultaneously applied with the number of RF frequencies corresponding to the number of wavelengths of optical signals to be dropped.

Transmission outputs of dropping sections 221 from which the transmitted WDM optical signals are output are connected to a K×K optical SW network 222, respectively, in a one-to-one manner,

The K×K optical SW network 222 may be the optical SW networks shown in the embodiment 1-1 through embodiment 1-4, or may be an optical SW network of a known type.

The outputs of the K×K optical SW network 222 are connected to plural K numbers of CPL's 223, respectively, in a one-to-one manner.

The outputs of CPL's 223 are connected to a plurality of optical transmission paths, respectively, in a one-to-one manner.

Meanwhile, the dropped outputs of the dropping sections 221, from which the dropped optical signal are output, are connected to plural K numbers of 1×N CPL's 224, in a one-to-one manner. In each 1×N CPL 224, plural N numbers of outputs of each 1×N CPL 224 are connected to an N·K×N·K optical SW network 226 via plural N numbers of wavelength selecting sections 225, respectively. The number of 1×N CPL's 224 is the plural, K, thereby finally requiring plural N·K numbers of wavelength selecting sections 225.

As the N·K×N·K optical SW network 226, the optical SW network of anyone of the embodiment 1-1 through embodiment 1-5 is utilized, and the outputs from the N·K×N·K optical SW network 226 become the optical signals to be dropped from the station 211.

Each wavelength selecting section 225 selects an optical signal of a desired wavelength from a plurality of input optical signals, and outputs the selected optical signal. For example, it is possible to mutually connect between first and second N×N AWG's through plural N numbers of SOA's, and to drive only the SOA connected to an output of the first AWG from which the light of the desired wavelength is output, so that only the light of the desired wavelength is selectively output from the second AWG.

On the other hand, the optical signals to be added from other optical networks are input to an N·K×N·K optical SW network 229. Also, as the N·K×N·K optical SW network 229, it is possible to utilize the optical SW network of anyone of the embodiment 1-1 through embodiment 1-5,

The outputs of the N·K×N·K optical SW network 229 are input to N×1 CPL's 227 via variable wavelength conversion sections 228, and collected into groups for each optical transmission path 212 to be added with the optical signals, respectively. The optical signals collected into one group in each CPL 227 are input to the CPL 223 connected to the aforementioned optical transmission path 212, added into the optical signal from the K×K optical SW network 222 so as to be then transmitted to the optical transmission path 212.

The functions and effects of the embodiment 1-9 will be described hereinafter.

Firstly, the functions and effects in a normal state will be described.

The N-wave multiplexed WDM optical signals being transmitted through the active A and B of the optical network Y are input to the dropping sections 221, respectively. Each dropping section 221 drops optical signals from the WDM optical signal, as required. The dropped optical signals are distributed into N numbers by the CPL 224, to be input to wavelength selecting sections 225, respectively. The wavelength selecting sections 225 are selected so that the dropped optical signals are output from desired output ports of the N·K×N·K optical SW network 226. The; dropped optical signals are output only from the selected wavelength selecting sections 225. The directional paths of the dropped optical signals input to the N·K×N·K optical SW network 226 are changed corresponding to the input positions and wavelengths of the dropped optical signals in the manner as described in the embodiment 1-1 through embodiment 1-5, so that these input optical signals are output from the desired output ports of the N·K×N·K optical SW network 226.

In this way, the optical signals of the active A in the optical network Y are dropped by the station 211-X1 to the active A optical transmission path group 212-X1 of the optical network X.

Similarly, the optical signals of the active B in the optical network Y are dropped by the station 211-X1 to the active B optical transmission path group 212-X2 of the optical network X.

For example, optical signals of 1 channel through 4 channel are dropped by the dropping section 221-1 from the WDM optical signal including 32 waves (32 channels) being transmitted through an optical transmission path 212-Y11. The dropped 1 channel through 4 channel are input to the CPL 224-1, and thereby distributed to the wavelength selecting sections 225-11 to 225-1N. The 1 channel through 4 channel are selected corresponding to the directional paths, such that only 1 channel is selected by the wavelength selecting section 225-11, 2 channel and 4 channel are selected by the wavelength selecting section 225-14, and only 3 channel is selected by the wavelength selecting section 225-1N. The channels input to predetermined input ports of the N·K×N·K optical SW network 226 are output from the desired output ports thereof, and transmitted to the desired optical transmission paths of the active A optical transmission path group 212-X1 of the optical network X.

On the other hand, the optical signals to be added from the active A optical transmission path group 212-X1 of the optical network X into the active A optical transmission path group 212-Y1 of the optical network Y. are input to predetermined input ports of the N·K×N·K optical SW network 229. The directional paths of the optical signals are changed corresponding to the input positions and wavelengths of the optical signals in the manner as described in the embodiment 1-1 through embodiment 1-5, so that these input optical signals are output from the desired output ports of the N·K×N·K optical SW network 229.

The optical signals output from the N·K×N·K optical SW network 229 are converted by the variable wavelength conversion sections 228 into those wavelengths of channels which are “emptied” by dropped at the dropping sections 221. Those wavelength-converted optical signals are multiplexed at CPL's 227, and then input to CPL's 223, respectively. Herein, the term “emptied” means that, in a WDM optical signal, an applicable optical signal is absent in the wavelength position (grid) into which the applicable optical signal is inherently multiplexed.

Further, the optical signals in the WDM optical signals, which are input to the dropping sections 221 and transmitted as they are, are input to the K×K optical SW network 222. The directional paths of the input signals are switched and then input to desired OPL's 223, respectively.

Each CPL 223 multiplexes, optical signals transmitting through the station 211-X1 and optical signals to be added, into a WDM optical signal, to transmit to the active A optical transmission path group 212-Y1 of the optical network Y.

In this way, the optical signals of the active A of the optical network X are added by the station 211-X1 to the active A optical, transmission path group 212-Y1 of the optical network Y.

Similarly, the optical signals of the active B of the optical network X are added by the station 211-X1 to the active B optical transmission path group 212-Y2 of the optical network Y.

For example, optical signals of 7 channel through 10 channel of the active A of the optical network X are input to the N·K×N·K optical SW network 229. The input 7 channel through 10 channel are input to the variable wavelength conversion sections 228, respectively. Further, for example, it is assumed that channel 29 through channel 32 are dropped by the dropping section 221-2 from the WDM optical signal transmitting through the optical transmission path 212-Y22, and the directional path of the remaining WDM optical signal is changed to the optical transmission path 212-Y11 by the K×K optical SW network 222. For example in this situation, the optical signal of channel 7 is output to the variable wavelength conversion section 228-12 and thereby converted into the wavelength of channel 31. The optical signal of channel 8 is output to the variable wavelength conversion section 228-14 and thereby converted into the wavelength of channel 30. The optical signal of channel 9 is output to the variable wavelength conversion section 228-18 and thereby converted into the wavelength of channel 32. The optical signal of channel 10 is output to the variable wavelength conversion section 228-IN and thereby converted into the wavelength of channel 29. Then, the optical signals of channel 29 through channel 32 converted are multiplexed by the CPL 227, then multiplexed by the CPL 223-1 into the optical signals of channel 1 through channel 28 which have been transmitted through the station 211-X1 and transmitted to the optical transmission path 212-Y11.

The functions and effects at the time of occurrence of a fault will be described hereinafter.

It is now assumed that a fault occurred in the active A optical transmission path group 212-Y1 at the downstream side of the station 211-X1, for example, so that the WDM optical signals can be noway transmitted by the active A optical transmission path group 212-Y1.

In this situation, the directional paths of the optical signals to be transmitted through the station 211-X1 of the optical network Y are switched by the K×K optical SW network 222 such that the optical signals are transmitted to the protective C optical transmission path group 212-Y3. Further, the directional paths of the optical signals to be added from the active A of the optical network X to the active A optical transmission path group 212-X1 of the optical network Y, are switched by the N·K×N·K optical SW network 229 such that these optical signals are transmitted to the protective C optical transmission path group 212-Y3. The similar explanation can be made for when a fault occurred in the active optical transmission path group 212-Y2.

In this way, the embodiment 1-9 is possible to realize a protection function for switching the directional path from the active to the protective when a fault occurred in an optical transmission path.

An embodiment 1-10 of the present invention will be described hereinafter.

This embodiment 1-10 is an embodiment of an optical network.

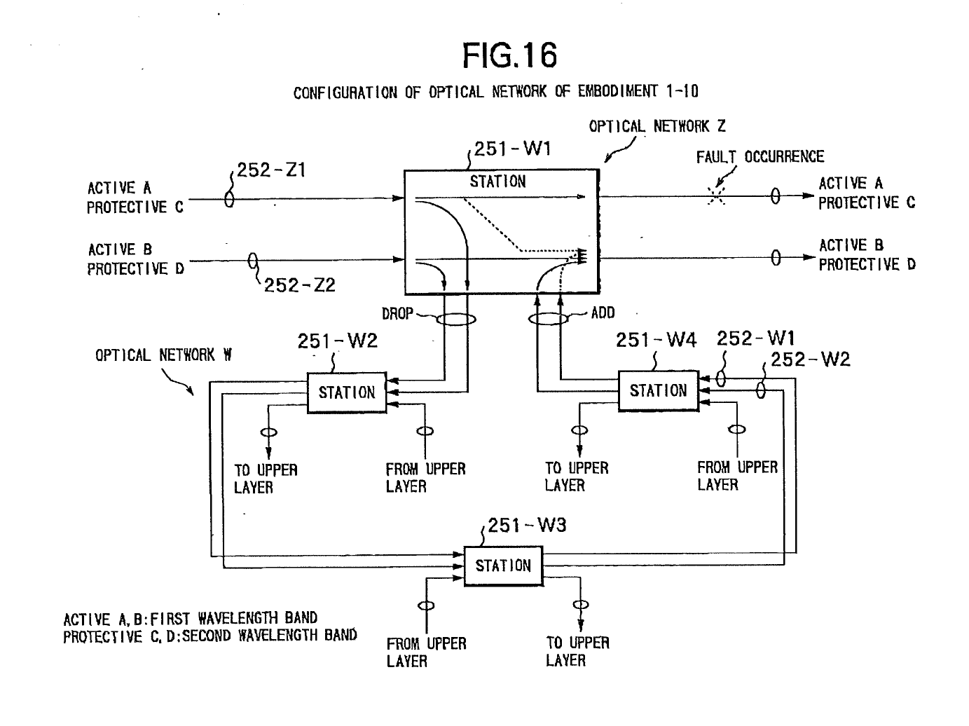

FIG. 16 is a diagram showing a configuration of the optical network of the embodiment 1-10.

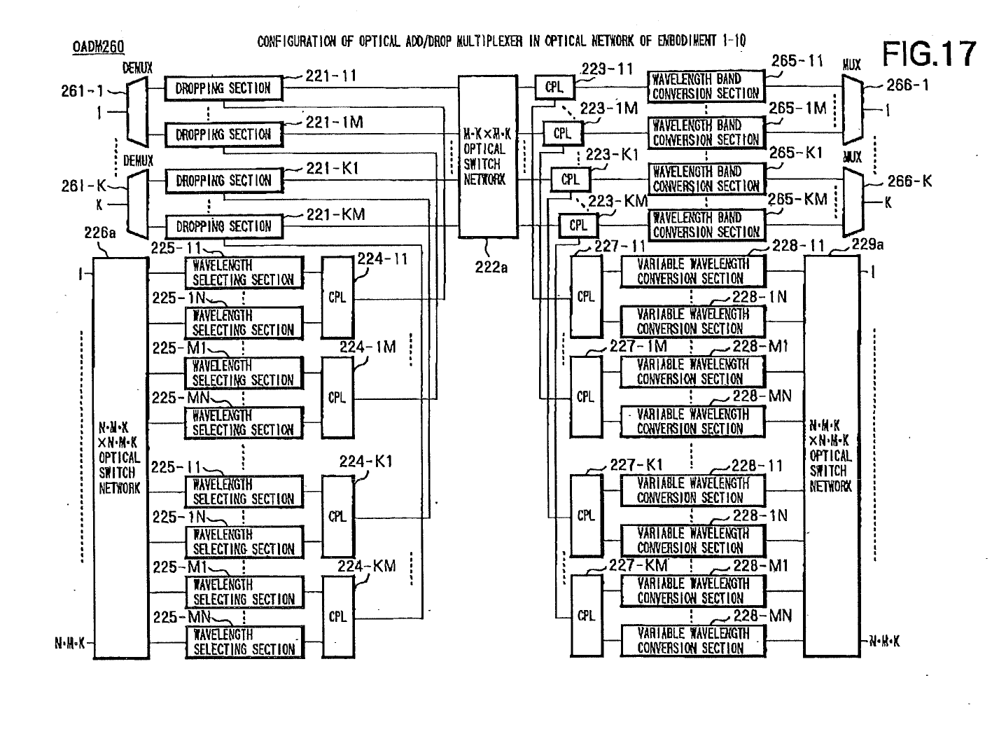

FIG. 17 is a diagram showing a configuration of an optical add/drop multiplexer in the optical network of the embodiment 1-10.

In FIG. 16, the optical network constitutes a ring-shaped network comprising a plurality of stations 251, each including an OADM, and a plurality of optical transmission paths 252 for connecting these stations 251.

FIG. 16 shows an optical network W and a part of an optical network Z. In the optical network W, the optical transmission paths 252 comprise two optical transmission path groups 252-W1, 252-W2, and the stations 251 comprise four stations 251-W1, 251-W2, 251-W3 and 251-W4. In the optical network Z, the optical transmission paths 252 comprise two optical transmission path groups 252-Z1, 252-Z2, and the station 251-W1 is provided between the optical networks W and Z as a station to add/drop optical signals.

The first wavelength bands of the optical transmission paths 252-W1 and optical transmission paths 252-Z1 are used for the active A, and the second wavelength bands of the optical transmission paths 252-W1 and optical transmission paths 252-Z1 are used as the protective C. Similarly, the first wavelength bands of the optical transmission paths 252-W2 and optical transmission paths 252-Z2 are used as the active B, and the second wavelength bands of the optical transmission paths 252-W2 and optical transmission paths 252-Z2 are used as the protective D. For example, C band and L band are used as the first and second wavelength bands, respectively,

The configuration of the OADM 260 provided in the station 251 will be described hereinafter.

As understood from the comparison with the configuration of the OADM 220 shown in FIG. 15, the OADM 260 of FIG. 17 is different from the OADM 220, in that the OADM 260 is further provided with plural K numbers of DEMUX's 261 for mutually separating the first wavelength band and second wavelength band, wavelength band converting sections 265 for converting the wavelength bands of WDM optical signals, respectively, and MUX's 266 for wavelength division multiplexing the optical signals. This difference results in that in optical transmission paths, the dropping sections 221 are input with WDM optical signals via the DEMUX's 261 at the input side of the OADM 260. Further, at the output side of the OADM 260, the outputs of CPL's 223 are input to the wavelength band converting sections 265, respectively, and wavelength division multiplexed to be output by the MUX's 266, respectively. As the optical SW networks 222a, 226a, 229a, those larger than the optical SW networks 222, 226, 229 of the embodiment 1-9 are used.

There shall be omitted the description of the configurations of the dropping sections 221, optical SW networks 222a, 226a, 229a, OPL's 223, 224, 227, wavelength selecting sections 225 and variable wavelength conversion sections 228, since these are the same as those shown in FIG. 15.

Here, each wavelength band converting section 265 is constituted to comprise an optical fiber for conducting wavelength band conversion and an excitation light source for supplying excitation light to the optical fiber, for example. Then, light in a certain wavelength band is input to the optical fiber together with the excitation light, and a wavelength of the light is converted into another wavelength band by a four wave mixing phenomenon by the excitation light within the optical fiber. The converted light is then emitted from the optical fiber.

The wavelength λout of output light has the relationship as represented by the following equation (6) with the wavelength λin of input light and the wavelength λpump of excitation light:

λout=2λin−λpump (6).

For example, if the WDM optical signal of C band includes λ1C=1535.8 nm to λ32C=1560.6 nm and the wavelength of the excitation light is λpump=1567.6 nm, this results in, the WDM optical signal of L band includes λ1L=1599.4 nm to λ32L=1574.6 nm.

Next, the functions and effects of the embodiment 1-10 will be described hereinafter,

In a normal state, each WDM type optical signal of two wavelength bands transmitted through each of optical transmission paths 252-Z1 of the optical network Z is wavelength-separated for each wavelength band into the active A WDM optical signal and the protective C WDM optical signal by the DEMUX 261. Each WDM type optical signal of two wavelength bands transmitted through each of optical transmission paths 252-Z2 of the optical network Z is wavelength-separated for each wavelength band into the active B WDM optical signal and the protective D WDM optical signal by the DEMUX 261.

There shall be omitted the description of the procedures for dropping the WDM optical signals of the active A and B and protective C and D from the optical network Z to the optical network W, since such procedures are the same as the embodiment 1-9.

Note, no WDM optical signals are present in the protective C and D wavelength bands, in the normal state where no faults have occurred in the optical transmission paths 252-Z1, 252-Z2.

In this way, the optical signals in the active A wavelength band of the optical network Z are dropped by the station 251-W1 into the optical transmission paths 252-W1 at the active A wavelength band of the optical network W. Similarly, the optical signals in the active B wavelength band of the optical network Z are added by the station 261-W1 into the optical transmission paths 252-W2 at the active B wavelength band of the optical network W.

Further, similarly to the embodiment 1-9, the optical signals to be added from the active A of the optical network W to the active A of the optical network Z are processed by the N·K×N·K optical SW network 229a, variable wavelength conversion sections 228 and CPL's 227, and then input to CPL's 223, respectively. CPL's 223 multiplex the optical signals transmitted through the station 251-W1 and the optical signals to be added, and input the thus obtained WDM optical signals to the wavelength band converting sections 265, respectively. Because of the normal state, the wavelength band converting sections 265 convert the input WDM optical signals into those of the active A wavelength bands and then output them. The output WDM optical signals are transmitted, via the MUX's 266, to the optical transmission paths 252-Z1 of the optical network Z, respectively.

In this way, the optical signals of the active A of the optical network W are added by the station 251-W1 to the optical transmission paths 252-Z1 at the active A wavelength bands of the optical network Z. Similarly, the optical signals of the active B of the optical network W are added by the station 251-W1 to the optical transmission paths 252-Z2 at the active B wavelength bands of the optical network Z.

It is now assumed that a fault occurred in the optical transmission paths 252-Z1 at the downstream side of the station 251-W1, such that WDM optical signals are unable to be transmitted via the optical transmission paths 252-Z1.

In this situation, the directional paths of the optical signals being transmitted, through the station 251-W1 of the optical network Z are switched by the optical SW network 222a such that these optical signals are transmitted to the optical transmission paths 252-Z2 at the protective D wavelength bands, and the wavelength bands of the optical signals are converted from the active A into the wavelength bands at the protective D by the wavelength band converting sections 265, respectively. Further, the directional paths of the optical signals to be added from the active A of the optical network Z to the active A of the optical network W, are switched by the optical SW network 229a such that these optical signals are transmitted to the optical transmission paths 252-Z2, and the wavelength bands of the optical signals are converted from the active A into the wavelength bands at the protective D by the wavelength band converting sections 265, respectively.

The optical signals transmitted through the station 251-W1 and optical signals to be added are input to the MUX's 266 at the protective D wavelength bands, respectively, and wavelength division multiplexed into the optical signals of the active B at the MUX's 266 to thereby mature to two wavelength band WDM optical signals, respectively, to be transmitted to the optical transmission paths 252-Z2.

In this way, the embodiment 1-10 is possible to realize a protection function at the time of occurrence of a fault in the optical transmission paths 252-Z1, by switching from the active A wavelength band to the protective D wavelength band by each wavelength band converting section 265.

Similarly, there can be realized a protection function at the time of occurrence of a fault in the optical transmission paths 252-Z2, by switching from the active B wavelength band to the protective C wavelength band by each wavelength band converting section 265.

Shown by broken lines in FIG. 14 and FIG. 16 are routes of optical signals in case of protection, respectively.

In each of the embodiment 1-9 and embodiment 1-10, there have been used CPL's 224 and wavelength selecting sections 225. Instead of these constituent parts, there can be used DEMUX's for separating input lights for each wavelength. Further, in each of the embodiment 1-9 and embodiment 1-10, there have been used variable wavelength conversion sections 228 and CPL's 227. Instead of these constituent parts, there can be used MUX's for wavelength division multiplexing input lights.

An embodiment 2-1 of the present invention will be described hereinafter.

This embodiment 2-1 is an embodiment of a 256×256 optical SW network, for example, corresponding to the second embodiment of the optical SW network according to the present invention,

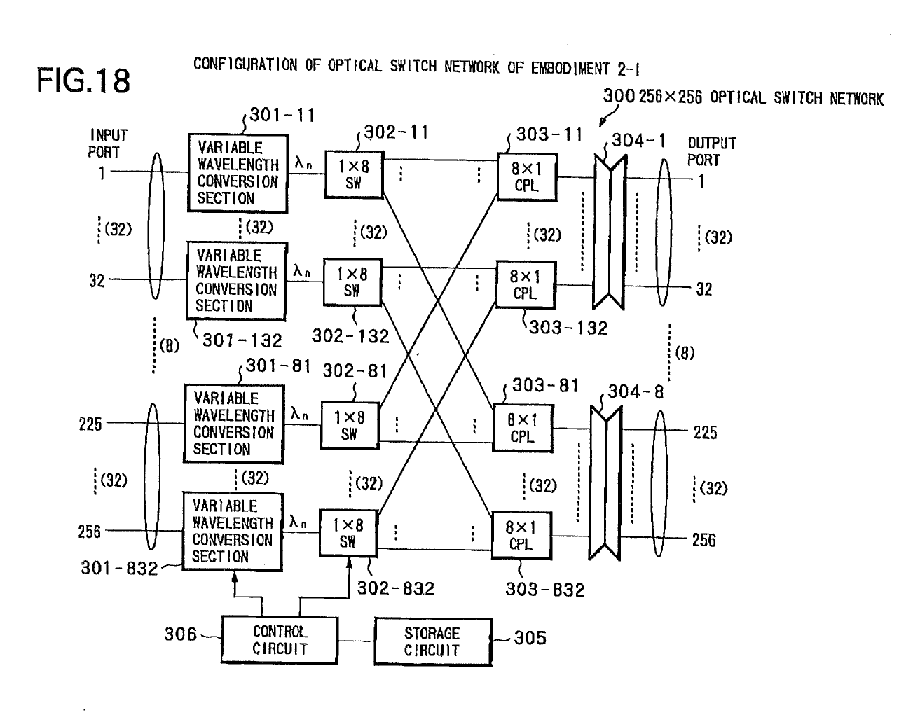

FIG. 18 is a diagram showing a configuration of the optical SW network of the embodiment 2-1.

In FIG. 1B, a 256×256 optical SW network 300 is provided with 256 numbers of variable wavelength conversion sections 301, 256 numbers of 1×8 SW's 302, and 256 numbers of 8×1 optical couplers (CPL's) 303, corresponding to 256 numbers of input ports and 256 numbers of output ports, and also provided with 8 numbers of 32×32 arrayed waveguide grating type optical MUX/DMUX devices (AWG's) 304 between the 8×1 optical couplers (CPL's) 303 and output ports. Further, there are provided a storage circuit 305 and a control circuit 306, as a configuration for controlling the operations of the variable wavelength conversion sections 301 and 1×8 SW's 302.

The, 256 numbers of input ports are connected to the 1×8 SW's 302 via the variable wavelength conversion sections 301, respectively. Herein, the input ports are divided into 8 groups, such that 32 numbers are virtually regarded as one bundle. Note, when the optical signals to be input to the 256×256 optical SW network 300 are WDM optical signals, it is possible to consider that the multiplicity of each WDM optical signal is 32 which is the number of input ports in one group, and that the number of optical transmission paths to be connected to the 256×256 optical SW network 300 is 8 which is the total number of groups.

Each variable wavelength conversion section 301 is capable of converting the wavelength of the optical signal input from the input port into an arbitrary wavelength λn (n is a positive integer; and for example, λn is one of wavelengths λ1 to λ32) which can be processed by the optical SW network 300. As a specific configuration of the variable wavelength conversion section 301, it is possible to adopt the variable wavelength conversion section having the configuration as shown in FIG. 5A and FIG. 5B.

8 numbers of outputs of a certain 1×8 SW 302 in 1×8 SW's 302 of the respective groups are connected to 8 numbers of 8×1 CPL's 303 belonging to different groups from one another in a one-to-one manner. Namely, a first output of a first 1×8 SW 302-11 of the first group is input to a first input of a first 8×1 CPL 303-11 of the first group, and a second output of the 1×8 SW 302-11 is input to a first input of a first 8×1 CPL 303-21 in second group, and so on. An eighth output of the 1×8 SW 302-11 is input to a first input of a first 8×1 CPL 303-81 in the eighth group. Further, a first output of a second 1×8 SW 302-12 of the first group is input to a first input of a second 8×1 CPL 303-12 of the first group, and a second output of the 1×8 SW 302-12 is input to a first input of a second 8×1 CPL 303-22 in second group, and so on. An eighth output of the 1×8 SW 302-12 is input to a first input of a second 8×1 CPL 303-82 in the eighth group. Similarly to the above, an eighth output of a 32-th 1×8 SW 302-132 in first group is input to a first input of a 32-th 8×1 CPL 303-832 in the eighth group. The 1×8 SW's 302 in the groups are similarly connected in the same manner as the above. In conclusion, a P-th output of a L-th 1×8 SW 302-KL in K-th group is input to a K-th input of a L-th 8×1 CPL 303-PL in P-th group.

Each 8×1 CPL 303 wavelength division multiplexes the optical signals input from input terminals thereof to which the 1×8 CPL 302 is connected into a WDM optical signal, to output it from a single output terminal thereof. Note, it is assumed that the control circuit 306 suitably controls the output wavelengths at the variable wavelength conversion sections 301 and the switching states of the 1×8 SW's 302, so as to prevent an occurrence of collision between wavelengths (a situation where lights of the same wavelengths are multiplexed) when multiplexing optical signals in each 8×1 CPL 303, Each 32×32 AWG 304 is a cyclic matrix switch for selecting the output port corresponding to the port position of the input optical signal and the wavelength of the optical signal. To be specific, it is possible to adopt the AWG having the configuration shown in FIG. 3A and the input/output relationships shown in FIG. 3B. In that case, it is assumed that the value M of the number of input/output waveguides in FIG. 3 is 32. Meanwhile, distally connected to the output waveguides of the 32×32 AWG's 304 are totally 256 numbers of output ports, respectively.

For example, in a 32×32 AWG 304-1 of the first group, the optical signal of wavelength λ1 input to a first input waveguide is emitted from a first output waveguide and then sent to a first output port, similarly to FIG. 3B. Further, the optical signal of wavelength λ2 input to the first input waveguide is emitted from a second output waveguide and then sent to a second output port, and so on. Similarly, the optical signal of wavelength λ32 input to the first input waveguide is emitted from a 32-th output waveguide and then sent to a 32-th output port. When the position of the input waveguide is shifted by L from the first to the (L+1)-th; the position of the output waveguide is also cyclically shifted by L. Thus, even when all the input waveguides are input with lights of the same wavelengths, respectively, the optical-signals are output from mutually different output ports, respectively, as already shown in FIG. 3B.

Such an AWG 304 is to multiplex/demultiplex the input lights by utilizing optical characteristics and structures as described above, so that the directional paths of input lights can be switched. Further, an insertion loss is relatively small such that a 32×32 AWG has an insertion loss on the order of 6 dB. Thus, each 32×32 AWG 304 is capable of switching directional paths of optical signals, at a lower insertion loss.

The storage circuit 305 stores therein, for example a wavelength-dependency input/output correspondence table showing corresponding relationships between input positions and wavelengths of input lights, and output positions, in each AWG 304, and a relationship table, for connecting the input ports and output ports, showing corresponding relationships among the variable wavelength conversion sections 301, 1×8 SW's 302, 8×1 CPL's 303 and AWG's 304. The control circuit 306 is connected to the storage circuit 305 to thereby control the output wavelengths of the variable wavelength conversion sections 301 and the switching states of 1×8 SW's 302, by referring to the respective tables.

The functions and effects of the embodiment 2-1 will be described hereinafter.

It is here assumed one example in that the optical signal input to a first input port 1 of the optical SW network 300 is output from a 256-th output port 256. Note, it can also be assumed a situation where the optical signal input to the input port 1 is output from another port, or where the directional path of the optical signal input to another input port is to be duly switched.

The optical signal input to the input port 1 is input to a first variable wavelength conversion section 301-11. The control circuit 306 identifies the input port 1 of the first group to which the optical signal is input, and also identifies the output port 256 of the eighth group from which the optical signal is to be output, by reading routing information indicating the directional path of this optical signal, or by receiving a command from a total switch controlling part (operation system).

The control circuit 306 switches the state of the 1×8 SW 302-11 to which the input port 1 of the first group is connected via the variable wavelength conversion section 301-11, such that the output of the 1×8 SW 302-11 is connected to the 8×1 CPL 303-81 of the eighth group. Further, the control circuit 306 refers to the wavelength-dependency input/output correspondence table stored in the storage circuit 305 to thereby determine the wavelength λ32 for rendering the optical signal output from the 8×1 CPL 303-81 of the eighth group, to be output from the output port 256, and outputs a control signal to the variable wavelength conversion section 301-11 to thereby convert the wavelength of the input light into the wavelength λ32.

Thus, the optical signal having been wavelength-converted into the wavelength λ32 is sent from the variable wavelength conversion section 301-11 of the first group to the 8×1 CPL 303-81 of the eighth group via the 1×8 SW 302-11. The 8×1 CPL 303-81 wavelength-multiplexes the optical signal from the 1×8 SW 302-11 of the first group and the optical signals from 1×8 SW's 302 of the other groups, into a WDM optical signal, and sends the WDM optical signal into the first input waveguide of a 32×32 AWG 304-8 of the eighth group.

The optical signal of the wavelength λ32 included in the WDM optical signal sent to the first input waveguide of the 32×32 AWG 304-8 of the eighth group, is sent to a 32-th output waveguide, and output from the output port 256 connected to this output waveguide.

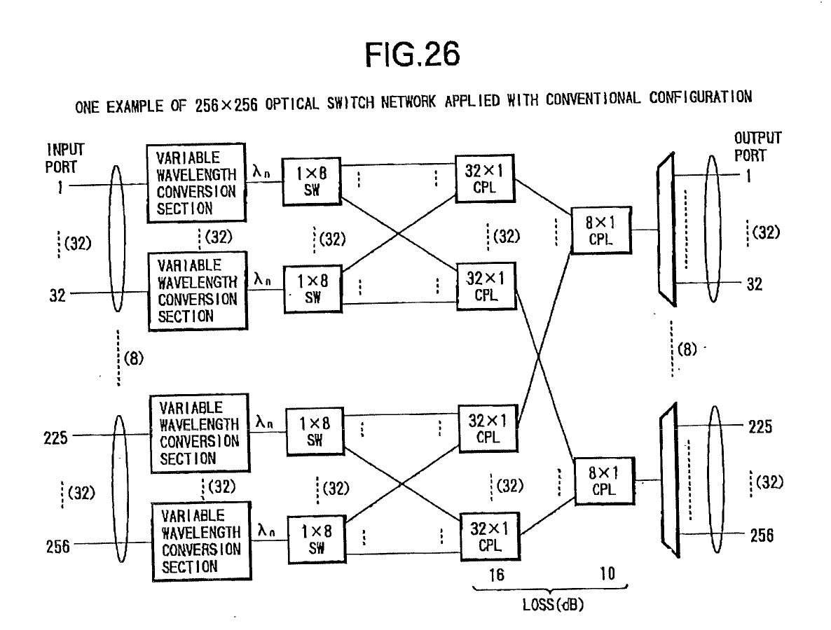

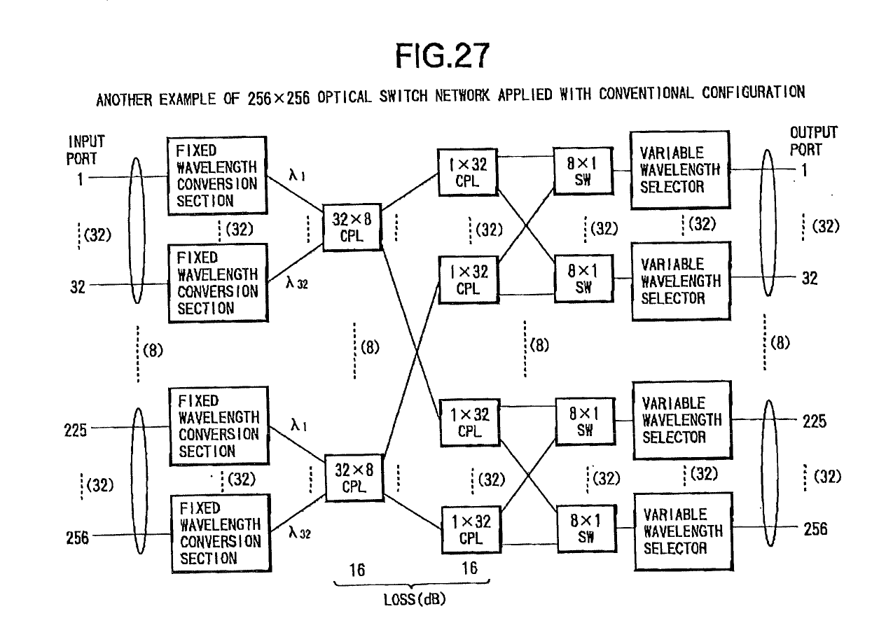

Approximating the loss in the optical SW network 300 for switching directional paths of optical signals in the above manner, there can be evaluated about 4 dB at the 1×8 SW 302, about 10 dB at the 8×1 CPL 303, and about 6 dB at the 32×32 AWG 304, thereby leading to a sum on the order of 20 dB. Meanwhile, in case of realizing a 256×256 optical SW network by applying a conventional configuration, optical signals pass through optical couplers each having the larger number of distributions, leading to a larger loss. Specifically, if as shown in FIG. 26, 32×1 OPL's and 8×1 CPL's are combined to be used for realizing a 256×256 optical SW network, a total loss of the respective CPL's reaches on the order of 26 dB. Further taking account of the loss due to other optical components constituting the optical SW network, the total loss of the optical SW network of FIG. 26 is larger by 10 dB or more than that of the optical SW network 300 of the present embodiment.

According to the optical SW network 300 of the embodiment 2-1 as described above, the directional paths are switched by arranging the 1×8 SW's 302 and AWG's 304 upstream and downstream of the optical couplers, respectively, thereby enaling to realize a 256×256 optical SW by utilizing 8×1 CPL's 303 each having the smaller number of distributions, so that reduction of loss in the optical SW network can be achieved.

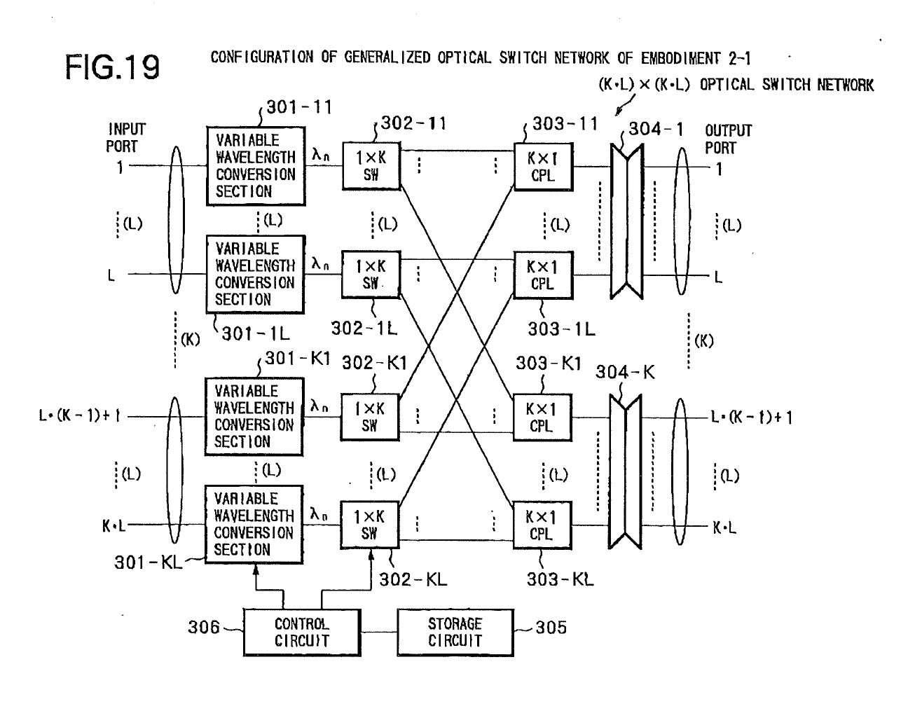

In the embodiment 2-1, there has been described the configuration of the 256×256 optical SW network. However, the number of input/output ports is not limited thereto. In generalizing the configuration of the embodiment 2-1, there is provided a (K·L)×(K·L) optical SW network, when input ports and output ports are divided into K groups each including L ports (K, L are positive integers). The exemplary configuration in this case is shown in FIG. 19 as an optical SW network 300′.

In the above, there has been described a situation where the optical signal is input to the first input port 1 of the 256 numbers of input ports of the optical SW network 300. However, even when the optical signals are simultaneously input to multiple input ports, the optical SW network 300 is capable of simultaneously changing directional paths of multiple optical signals since the control circuit 306 controls the wavelengths of the multiple optical signals corresponding to the wavelength-dependency input/output characteristics of the AWG's, respectively.

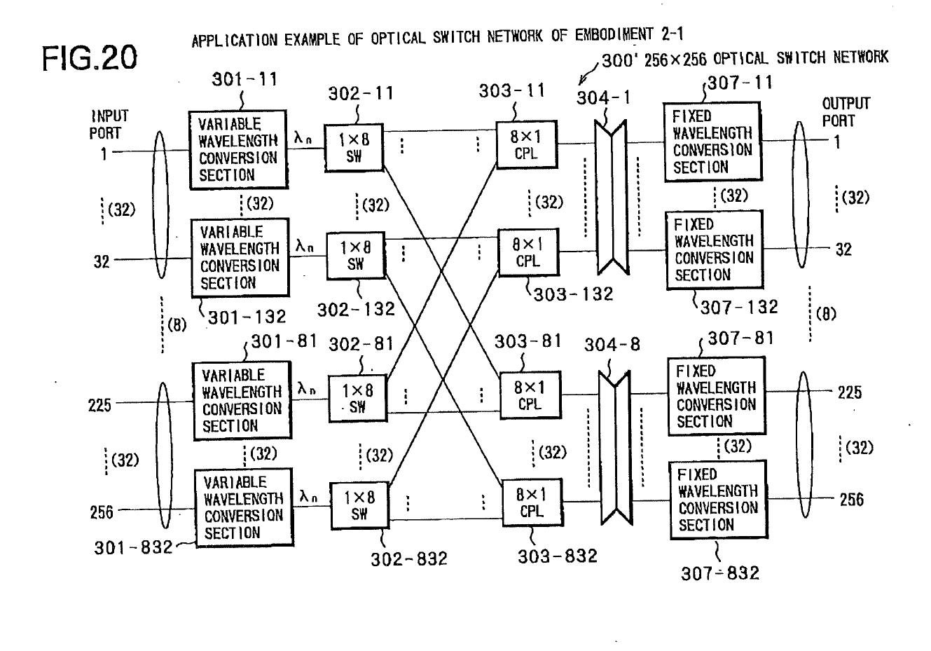

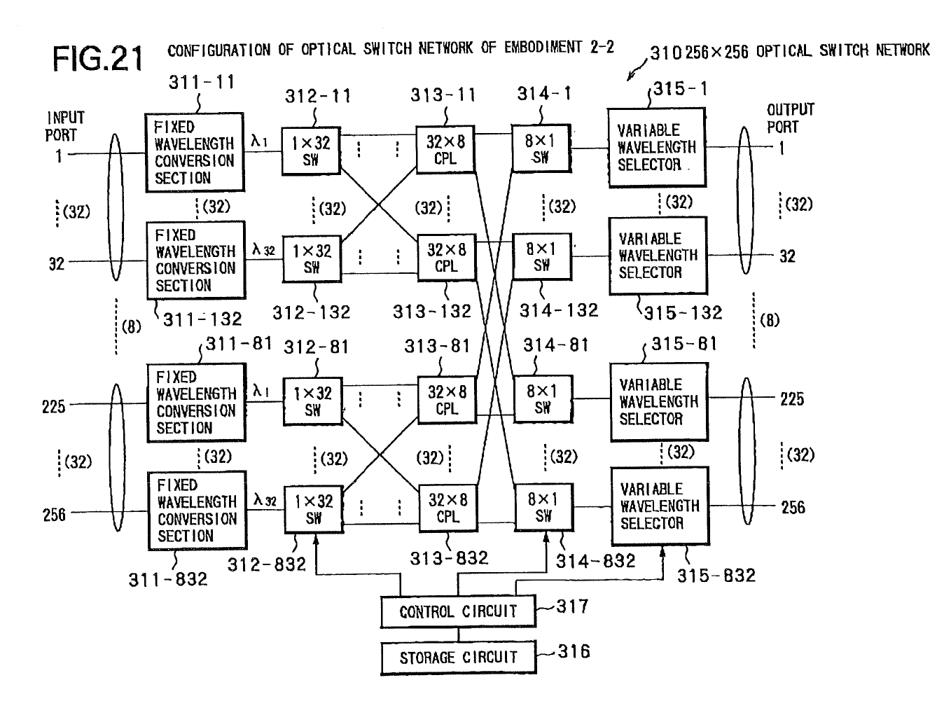

Further, an application example of the 256×256 optical SW network 300 of the embodiment 2-1, as shown in FIG. 20, fixed wavelength conversion sections 307 may be provided between output terminals of 32×32 AWG's 304 and output ports, respectively. Note, the storage circuit 305 and control circuit 306 are omitted in the exemplary configuration of FIG. 20. Each fixed wavelength conversion section 307 is provided from the standpoint to convert the wavelength of the optical signal to be emitted from the output port into a predetermined wavelength. Each fixed wavelength conversion section 307 can be constituted such that, in the variable wavelength conversion section 51 shown in FIG, 5A, the light source 92 is substituted by a light source for oscillating at a predetermined single wavelength. As such a light source, it is possible to utilize various semiconductor lasers including Fabry-Perot type, distributed feedback type, distributed Bragg reflecting type.

An embodiment 2-2 of the present invention will be described hereinafter.

The embodiment 2-2 is another embodiment of a 256×256 optical SW network, for example, corresponding to the second aspect of an optical switch network according to the present invention.

FIG. 21 a diagram showing a configuration of the optical SW network of the embodiment 2-2.

FIG. 21 shows a 256×256 optical SW network 310 constituted to comprise 256 numbers of fixed wavelength conversion sections 311, 256 numbers of 1×32 SW's 312, 256 numbers of 32×8 optical couplers (CPL) 313, 256 numbers of 8×1 SW's 314 and 256 numbers of variable wavelength selectors 315, corresponding to 256 numbers of input ports and 256 numbers of output ports. There are provided a storage circuit 316 and a control circuit 317, for controlling the operations of the 1×32 SW's 312 and 8×1 SW's 314 and variable wavelength selectors 315.

The 256 numbers of input ports are connected to 1×32 SW's 312 via the fixed wavelength conversion sections 311, respectively. Similarly to the embodiment 2-1, the input ports are divided into 8 groups, such that 32 numbers are virtually regarded as one bundle.

Each fixed wavelength conversion section 311 converts the wavelength of the optical signal input from the input port into a previously set wavelength among wavelengths which can be processed by the optical SW network 310. Here, it is now assumed that, for example, a first fixed wavelength conversion section 311-11 of the first group outputs an optical signal of wavelength λ1, a second fixed wavelength conversion section 311-12 outputs an optical signal of wavelength λ2, and so on, and a 32-th fixed wavelength conversion section 311-132 outputs an optical signal of wavelength λ32. It is further assumed that the fixed wavelength conversion sections 311 of the second group through eighth group are to output optical signals in the same manner as that of the first group. Note, by converting the wavelength of each input light into a particular wavelength in this way, it becomes possible to prevent an occurrence of collision between wavelengths (a situation where lights of the same wavelengths are multiplexed) when multiplexing optical signals in each 32×8 CPL 313 to be described later. The aforementioned fixed wavelength conversion section 311 can be constituted by substituting the light source 92 by a light source for oscillating at a predetermined single wavelength, for the configuration of the variable wavelength conversion section 51 shown in FIG. 5A.

32 numbers of outputs of a certain 1×32 SW 312 in each group are connected to 32 numbers of 32×8 CPL's 313 belonging to the same group, in atone-to-one manner. Namely, in the first group, a first output of a first 1×32 SW 312-11 is input to a first input of a first 32×8 CPL 313-11, a second output of the 1×32 SW 312-11 is input to a first input of the second 32×8 CPL 313-12, and so on, and a 32-th output of the 1×32 SW 312-11 is input to a first input of a 32-th 32×8 CPL 313-132. Further, in the first group, a first output of a second 1×32 SW 312-12 is input to a second input of the first 32×8 CPL 313-11, a second output of the 1×32 SW 312-12 is input to a second input of the second 32×8 CPL 313-12, and so on, and a 32-th output of the 1×32 SW 312-12 is input to a second input of the 32-th 32×8 CPL 313-132. Similarly to the above, a 32-th output of a 32-th 1×32 SW 312-132 in the first group is input to a 32-th input of the 32×8 CPL 313-132 in the same group. The outputs of 1×32 SW's 312 in the respective groups are connected in the same manner as the above, so that a P-th output of a L-th 1×32 SW 312-KL in K-th group is input to a L-th input of a P-th 32×8 CPL 313-KP of K-th group.

Each 32×8 CPL 313 wavelengthd division multiplexes the optical signals from each 1×32 SW's 312 connected to input terminals thereof into a WDM optical signal, and then branches the WDM optical signal into 8 numbers of WDM optical signals which are to be then output from the 8 numbers of output terminals of the 32×8 CPL 313, respectively. The 8 numbers of outputs of a certain 32>8 CPL 313 are connected to 8 numbers of 8×1 SW's 314 belonging to mutually different groups, respectively, in a one-to-one manner. Namely, a first output of the first 32×8 CPL 313-11 in the first group is input to a first input of a first 1×8 SW 314-11 in the first group, a second output of the 32×8 CPL 313-11 is input to a first input of the first 1×8 SW 314-21 in the second group, and so on, and an eighth output of the 32×8 CPL 313-11 is input to a first input of a first 1×8 SW 314-81 of the eighth group. Further, a first output of the second 32×8 CPL 313-12 in the first group is input to a first input of a second 1×8 SW 314-12 in the first group, a second output of the 32×8 CPL 313-12 is input to a first input of a second 1×8 SW 314-22 in the second group, and so on, and an eighth output of the 32×8 CPL 313-12 is input to a first input of a second 1×8 SW 314-B2 in the eighth group. Similarly to the above, an eighth output of the 32-th 32×8 CPL 313-132 of the first group is input to a first input of a 32-th 1×8 SW 314-832 of the eighth group. The outputs of 32×8 CPL's 313 in the respective groups are connected in the same manner as the above, so that a P-th output of a L-th 32×8 CPL 313-KL in the K-th group is input to a K-th input of a L-th 1×8 SW 314-PL of a P-th group.

Each 8×1 SW 314 selects one of the WDM optical signals from the 8 numbers of 32×8 CPL's 313 belonging to mutually different groups, and sends the selected one to the corresponding variable wavelength selector 315. The switching state of input/output of each 8×1 SW 314 is controlled by the control circuit 317.

Each variable wavelength selector 315 is an optical device for selectively transmitting an optical signal of the wavelength which is to be output to the output port, from the optical signals of the wavelengths λ1 to λ32, respectively, included in the WDM optical signal sent from the 8×1 SW 314. The wavelength of the transmitted light to be selected by each variable wavelength selector 315 is controlled by the control circuit 317.

The storage circuit 316 stores therein a relationship table, for connecting the input ports and output ports, such as showing corresponding relationships among the fixed wavelength conversion sections 311, 1×32 SW's 312, 32×8 CPL's 313, 8×1 SW's 314 and variable wavelength selectors 316. The control circuit 317 is connected to the storage circuit 316 and refers to the information stored therein, to thereby control the switching states of the 1×32 SW's 312 and 8×1 SW's 314 and the wavelengths to be selected by variable wavelength selectors 315, respectively.

The functions and effects of the embodiment 2-2 will be described hereinafter.

Similarly to the embodiment 2-1, it is assumed one example in that the optical signal input to the first input port 1 of the optical SW network 310 is to be output from the 256-th output port 256.

The optical signal input to the input port 1 is input to the first fixed wavelength conversion section 311-11 in the first group. The control circuit 317 then identifies the input port 1 of the first group into which the optical signal is input, and also identifies the output port 256 of the eigth group from which the optical signal is to be output, by reading routing information indicating the directional path of this optical signal, or by receiving the command from a total switch controlling part.

The control circuit 317 switches the state of the 1×32 SW 312-11 connected with the input port 1 of the first group via the fixed wavelength conversion section 311-11, such that the output of the 1×32 SW 312-11 is connected to the 32-th 32×8 CPL 313-132 in the first group. Simultaneously therewith; the control circuit 317 switches the state of the 1×8 SW 314-832 connected to the output port 256 of the eighth group via a variable wavelength selector 315-832, such that an input of the 1×8 SW 314-832 is connected to the 32-th 32×8 CPL 313-132 of the first group. Further, the control circuit 317 outputs a control signal to the variable wavelength selector 315-832, so that the optical signal of the wavelength λ32 is selected to transmitted.

Thus, the optical signal the wavelength thereof having been converted into the wavelength λ32 is sent from the fixed wavelength conversion section 311-11 of the first group, to the 32-th 32×8 CPL 313-132 of the first group via the 1×32 SW 312-11. The 32×38 CPL 313-132 wavelength division multiplexes the optical signals from the 1×32 SW's 312 of the first group into a WDM optical signal, and then branches the WDM optical signal into 8 numbers of WDM optical signals, to send to the 32-th 8×1 SW's 314 of the respective groups.

In the 32-th 1×8 SW 314-832 of the eighth group, one input terminal connected to the 32×8 CPL 313-132 of the first group among the input terminals connected to the 32-th 32×8 CPL's 313 of the respective groups, is connected to a single output. Thus, the WDM optical signal from the 32×8 CPL 313-132 is sent to the variable wavelength selector 315-832. From the WDM optical signal sent to the variable wavelength selector 315-832, only the optical signal of the wavelength λ32 is transmitted, to be output from the 256-th output port.

Approximating the loss in the optical SW network 310 for switching directional paths of optical signals in the above manner, there can be evaluated about 4 dB at the 1×32 SW 312, about 16 dB at the 32×8 CPL 313, about 4 dB at the 8×1 SW 314, and about 6 dB at the variable wavelength selector 315, thereby evaluating a sum on the order of 30 dB. Meanwhile, there is caused a larger loss in case of realizing a 256×256 optical SW network by applying a conventional configuration, in which optical signals pass through optical couplers each having the larger number of distributions. Specifically, if 32×8 CPL's and 1×32 CPL's as shown in FIG. 27 are combined to be used for realizing the 256×256 optical SW network of the embodiment 2-2 adopting the fixed wavelength conversion sections and variable wavelength selectors shown in embodiment 2-2 the total loss reaches on the order of 32 dB of the respective CPL's. Further taking account of the loss due to other optical components constituting the optical SW network, the loss becomes larger by about 10 dB or more than the optical SW network 310 of the embodiment 2-2 of the present invention.

According to the optical SW network 310 of the embodiment 2-2 as described above, the directional paths are switched by arranging the fixed wavelength conversion sections 311 and 1×32 SW's 312 upstream of the optical couplers 313 and by arranging 8×1 SW's 314 and variable wavelength selectors 315 downstream of the optical couplers 313, respectively, thereby enabling to realize a 256×256 optical SW by utilizing 32×8 CPL's 313 each having the smaller number of distributions, so that reduction of loss in the optical SW network can be achieved.

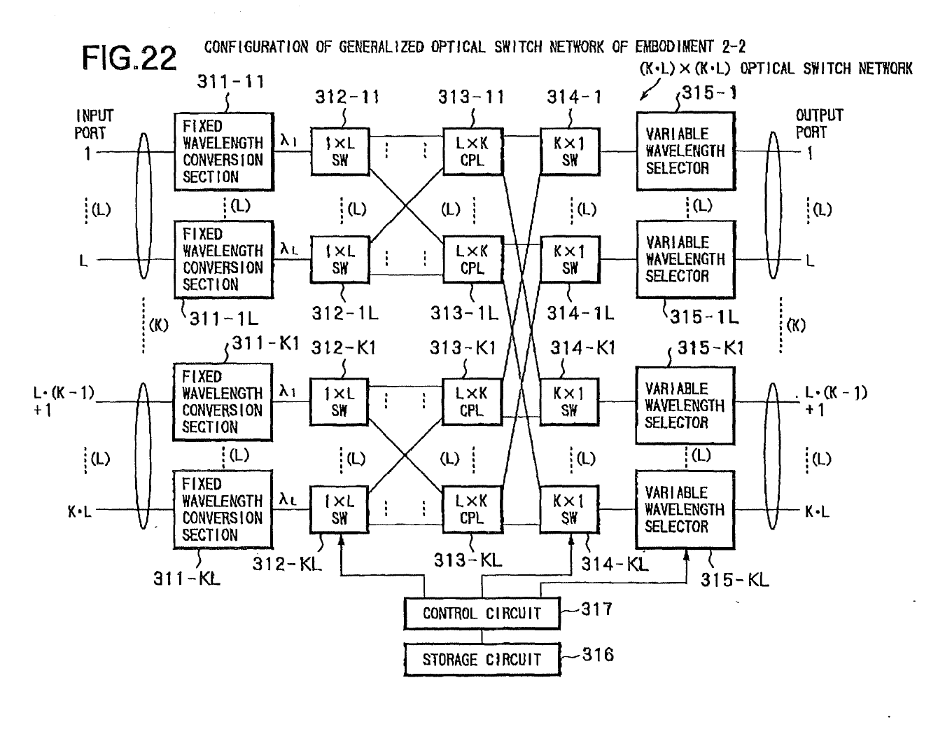

Also in the embodiment 2-2, there has been described the configuration of the 256×256 optical SW network. However, the number of input/output ports is not limited thereto. In generalizing the configuration of the embodiment 2-2, there is provided a (K·L)×(K·L) optical SW network, when input ports and output ports are divided into K groups each including L ports (K, L are positive integers). The exemplary configuration in this case is shown in FIG. 22 as an optical SW network 310.

In the above, there has been described a situation where the optical signal is input to the first input port 1 of the 256 numbers of input ports of the optical SW network 310. However, the optical SW network 310 is capable of simultaneously changing directional paths of multiple optical signals even when the optical signals are simultaneously input to multiple input ports, by appropriately controlling the operations of the 1×32 SW's 312, 8×1 SW's 314 and variable wavelength selectors 315.

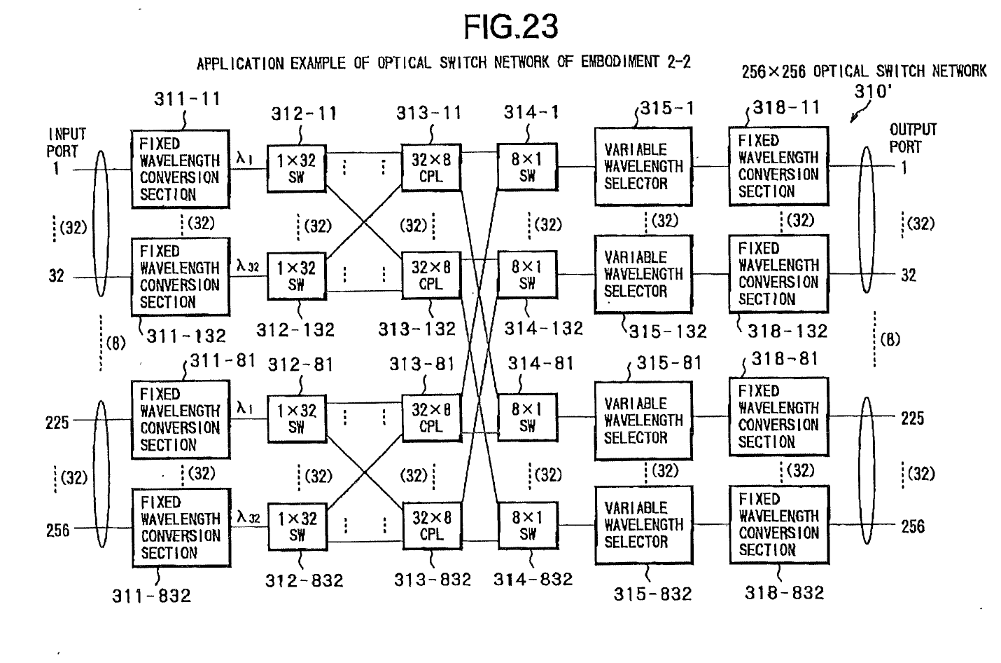

Further, as an application examplee of the 256×256 optical SW network 310 of the embodiment 2-2, as shown in FIG. 23, fixed wavelength conversion sections 318 may be provided between output terminals of variable wavelength selectors 315 and, output ports, respectively. Note, the storage circuit 316 and control circuit 317 are omitted in the exemplary configuration of FIG. 23. Each fixed wavelength conversion section 318 is provided from the standpoint to convert the optical signal to be emitted from the output port into a predetermined wavelength. Each fixed wavelength conversion section 318 can be constituted by substituting the fight source 92 by a light source for oscillating a predetermined single wavelength, for the variable wavelength conversion section 51 shown in FIG. 5A.

An embodiment 2-3 of the present invention will be described, This embodiment 2-3 is an embodiment of an optical cross connecting device (optical XC) applied with the aforementioned optical switch network of the embodiment 2-1.

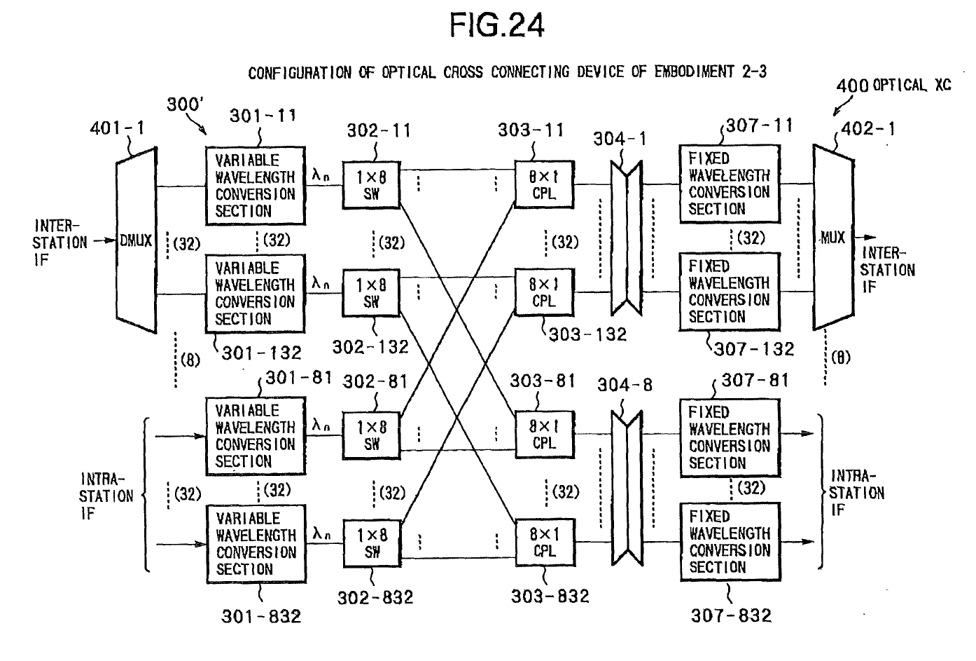

FIG. 24 is a diagram showing a configuration of the optical XC of the embodiment 2-3.

In FIG. 24, an optical XC 400 is applied with the configuration of the 256×256 optical SW network 300′ shown in FIG. 20, so as to realize cross-connection of WDM optical signals to be transmitted through 7 numbers of optical transmission paths corresponding to inter-station interfaces (IF's) and through a plurality of optical transmission paths corresponding to an intra-station interface (IF).

Specifically, the WDM optical signal having been transmitted through the optical transmission path of each inter-station IF is wavelength-separated by each optical demultiplexer (DEMUX) 401 and sent to corresponding input ports of the optical SW network 300′. Further, the optical signals of the respective wavelengths having beentransmitted through optical transmission paths of the intra-station IF are directly sent to corresponding input ports of the optical SW network 300′. The optical signals of the respective wavelengths to be output from output ports of the optical SW network 300′ are wavelength division multiplexed by an optical multiplexer (MUX) 402 for each inter-station IF and then sent to the corresponding optical transmission path, or directly sent to optical transmission paths of the intra-station IF. Note, as the DEMUX 401 and MUX 402, it is possible to utilize multilayered dielectric film filters or AWG's, for example.

In the aforementioned optical XC 400 of the embodiment 2-3, the 32-wave WDM optical signal transmitted through a first optical transmission path of the inter-station IF is input to a DEMUX 401-1, and wavelength-separated for each wavelength, and then, as the first group of optical signals, input to input ports of the 256×256 optical SW network 300′, respectively. The directional paths of the optical signals input to the 256×256 optical SW network 300′ are switched in the same manner as the embodiment 2-1, and the wavelengths of the optical signals are finally converted into predetermined wavelengths at the corresponding fixed wavelength conversion sections 307, respectively. Thereafter, these optical signals are transmitted to the optical transmission path of the inter-station IF via the MUX 402, or transmitted to optical transmission paths of the intra-station IF.

Since the WDM optical signal to be transmitted through each inter-station IF includes 32 waves in the above, it shall be assumed that the fixed wavelengths at 32 numbers of fixed wavelength conversion sections 307 connected to one MUX 402 are assigned with one of wavelengths λ1 to λ32 such that none of wavelengths λ1 to λ32 is overlappedly used.

According to the optical XC of the embodiment 2-3, the 258×256 optical SW network 300′ changes the directional path of an optical signal input from an arbitrary optical transmission path of the intra-station IF or the inter-station IF's, such that the thus directional path changed optical signal can be output to an arbitrary one of the optical transmission paths of the inter-station IF's and the optical transmission paths of the intra-station IF.

An embodiment 2-4 of the present invention will be described hereinafter.

This embodiment 2-4 is an embodiment of an optical cross connecting device (optical XC) applied with the optical switch network of the aforementioned embodiment 2-2.

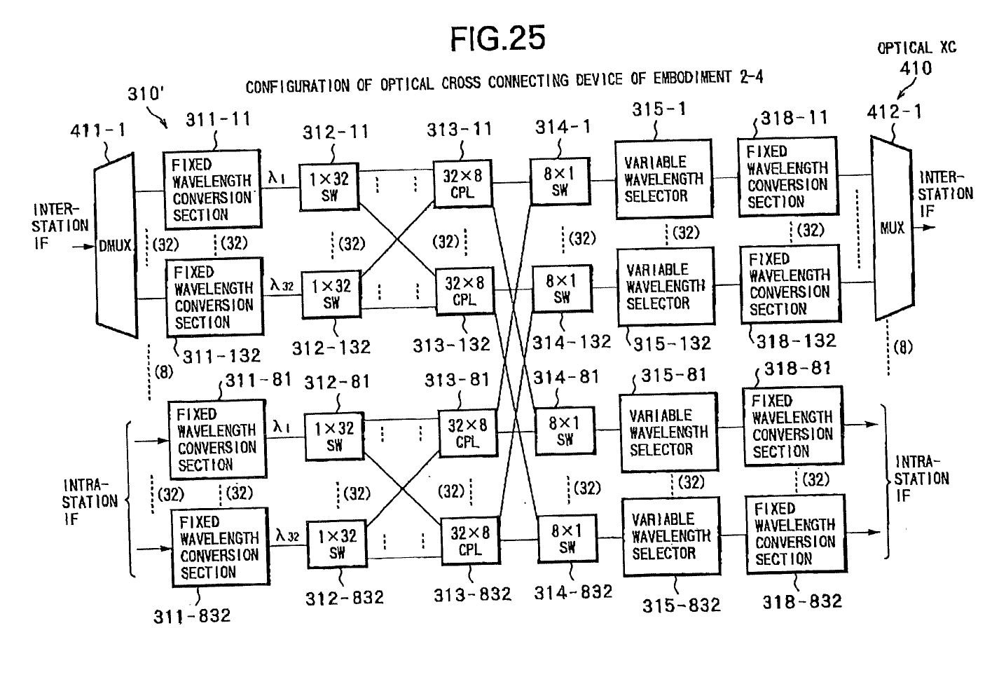

FIG. 25 is a diagram showing a configuration of the optical XC of embodiment 2-4.

In FIG. 25, similarly to the embodiment 2-3, an optical XC 410 is applied with the configuration of the 256×256 optical SW network 310′ shown in FIG. 23, so as to realize cross-connection of WDM optical signals to be transmitted through 7 numbers of optical transmission paths corresponding to inter-station IF's and through a plurality of optical transmission paths corresponding to an intra-station IF.

Specifically, the WDM optical signal having been transmitted through the optical transmission path of each inter-station IF is wavelength-separated for each wavelength by each optical demultiplexer (DEMUX) 411 and sent to corresponding input ports of the optical SW network 310′. Further, the optical signals of the respective wavelengths having been transmitted through optical transmission paths of the intra-station IF are directly sent to corresponding to input ports of the optical SW network 310′. The optical signals of the respective wavelengths to be output from output ports of the optical SW network 310′ are wavelength division multiplexed by an optical multiplexer (MUX) 412 for each inter-station IF and then sent to the corresponding optical transmission path, or directly sent to optical transmission paths of the intra-station IF. Note, as the DEMUX 411 and MUX 412, it is possible to utilize multilayered dielectric film filters or AWG's, for example.

In the aforementioned optical XC 410 of the embodiment 2-4, similar to the embodiment 2-3, the 32-wave WDM optical signal transmitted through the optical transmission path of the first inter-station IF is input to a DEMUX 411-1, wavelength-separated for each wavelength, and then, as the first group of optical signals, input to input ports of the 256×256 optical SW network 310′, respectively. The directional paths of the optical signals input to the 256×256 optical SW network 310′ are switched in the same manner as the embodiment 2-2, and the wavelengths of the optical signals are finally converted into predetermined wavelengths at the corresponding fixed wavelength conversion sections 318, respectively. Thereafter, these optical signals are transmitted to the optical transmission path of the inter-station IF via. the MUX 412, or transmitted to optical transmission paths of the intra-station IF.

Also according to the optical XC of the embodiment 2-4, the 256×256 optical SW network 310′ changes the directional path of a WDM optical signal input from an arbitrary one of the optical transmission paths of the intra-station IF or IF's, such that the thus directional path changed optical signal can be output to an arbitrary one of the optical transmission paths of the inter-station IF's, and the optical transmission paths of the intra-station IF.

In the embodiment 2-3 and embodiment 2-4, the optical XC has been constituted by adopting the 256×256 optical SW network. However, the optical XC of the present invention is not limited thereto. As a generalized configuration, it is possible to apply the (K·L)×(K·L) optical SW network shown in FIG. 19 or FIG. 22. In applying the configuration of FIG. 19 or FIG. 22 to an optical XC, there shall be provided a fixed wavelength conversion section for each output port of the (K·L)×(K·L) optical SW network.

It is also possible to construct an optical network, by utilizing the optical XC of the embodiment 2-3 or embodiment 2-4. Specifically, it is possible to utilize the configuration of the optical XC of the embodiment 2-3 or embodiment 2-4 as a configuration of an optical add/drop multiplexer in an intra-station environment on a network, similarly to the embodiment 1-9 or embodiment 1-10.

Further, concerning the aforementioned embodiment 1-1 through embodiment 2-4, it is possible to provide optical amplifiers at arbitrary positions between input ports and output ports, respectively, if it is required to compensate for-a loss in the optical SW network.

What is claimed:

1. An optical switch network comprising:
a plurality of input ports;
a plurality of output ports;
a plurality of wavelength converting means provided corresponding to said plurality of input ports, respectively, for each converting a wavelength of light input from each of said input ports; and
selecting means for outputting output lights from said plurality of wavelength converting means to particular ports of said output ports, respectively, corresponding to the wavelengths of the output lights.

2. An optical switch network of claim 1,
wherein a plurality of said selecting means are provided; and
wherein said optical switch network further comprises optical switches for switching the outputs of said plurality of wavelength converting means to arbitrary ones of said plurality of selecting means, respectively.

3. An optical switch network of claim 1,
wherein a plurality of said selecting means are provided; and
said optical switch network further comprises:
first optical switching means for switching the outputs of said plurality of wavelength converting means to arbitrary ones of said plurality of selecting means, respectively; and
second optical switching means for switching the outputs from said plurality of selecting means to arbitrary ones of said output ports, respectively.

4. An optical switch network of claim 3,
wherein said first optical switching means and said second optical switching means are provided in plural, respectively.

5. An optical switch network of claim 4,
wherein said plurality of input ports are divided into plural numbers of groups;
said plurality of selecting means are provided for the numbers equal to said plural numbers of groups;
said plurality of first optical switching means switch the outputs of said plurality of wavelength converting means to said plural numbers of selecting means; and
said plurality of second optical switching means switch the outputs of said plural numbers of selecting means to particular ones of said plurality of output ports, respectively.

6. An optical switch network of claim 1, further comprising:
a plurality of wavelength converting means for converting wavelengths of lights, for said plurality of output ports, respectively.

7. An optical cross connecting device, comprising:
wavelength-separating means for wavelength-separating wavelength division multiplexed light;
an optical switch network including a plurality of input ports to which a plurality of outputs of said wavelength-separating means are connected, respectively;
a plurality of fixed wavelength converting means corresponding to a plurality of output ports of said optical switch network, for converting wavelengths of lights; and
a plurality of wavelength-multiplexing means for wavelength-multiplexing output lights from said plurality of fixed wavelength converting means, respectively;
wherein said optical switch network comprises:
said plurality of input ports;
said plurality of output ports;
a plurality of wavelength converting means provided corresponding to said plurality of input ports, respectively, for converting wavelengths of lights input from said input ports, respectively; and
selecting means for outputting output lights from said plurality of wavelength converting means to particular ones of said output ports respectively, corresponding to wavelengths of the output lights.

8. An optical cross connecting device of claim 7,
wherein said wavelength-separating means wavelength-separates the input light into a plurality of lights according to wavelength bands, and further wavelength-separates said plurality of lights into a plurality of lights of mutually different wavelengths in each wavelength bands, respectively.

9. An optical cross connecting device of claim 7,
wherein said plurality of wavelength-multiplexing means wavelength-multiplexes the input lights into a plurality of lights according to wavelength bands, and for further wavelength-multiplexes said plurality of lights in said plurality of wavelength bands into a wavelength division multiplexed light.

10. An optical add/drop multiplexer comprising:
a dropping section for dropping predetermined optical signals from a wavelength division multiplexed optical signal comprising a plurality of optical signals having been multiplexed;
an adding section for adding predetermined optical signals into the wavelength division multiplexed optical signal output from said dropping section; and
an optical switch network for changing directional paths of the predetermined optical signals output from said dropping section into predetermined directional paths;
wherein said optical switch network comprises:
a plurality of input ports;
a plurality of output ports;
a plurality of wavelength converting means provided corresponding to said plurality of input ports, respectively, for converting wavelengths of lights input from said input ports, respectively; and
selecting means for outputting output lights from said plurality of wavelength converting means to particular ones of said output ports respectively, corresponding to wavelengths of the output lights.

11. An optical add/drop multiplexer comprising:
a dropping section for dropping predetermined optical signals from a wavelength division multiplexed optical signal comprising a plurality of optical signals having been multiplexed;
an adding section for adding predetermined optical signals into the wavelength division multiplexed optical signal output from said dropping section; and
an optical switch network for changing directional paths of input optical signals, so as to output the input optical signals to said adding section;
wherein said optical switch network comprises:
a plurality of input ports;
a plurality of output ports;
a plurality of wavelength converting means provided corresponding to said plurality of input ports, respectively, for converting wavelengths of lights input from said input ports, respectively; and
selecting means for outputting output lights from said plurality of wavelength converting means to particular ones of said output ports respectively, corresponding to wavelengths of the output lights.

12. An optical add/drop multiplexer comprising:
a dropping section for dropping predetermined optical signals from a wavelength division multiplexed optical signal comprising a plurality of optical signals having been multiplexed;
an adding section for adding predetermined optical signals into the wavelength division multiplexed optical signal output from said dropping section;
a first optical switch network for changing directional paths of the predetermined optical signals output from said dropping section into predetermined directional paths; and
a second optical switch network for changing directional paths of input optical signals, so as to output the input optical signals to said adding section;
wherein each of said first optical switch network and said second optical switch network comprises:
a plurality of input ports;
a plurality of output ports;
a plurality of wavelength converting means provided corresponding to said plurality of input ports, respectively, for converting wavelengths of lights input from said input ports, respectively; and
selecting means for outputting output lights from said plurality of wavelength converting means to particular ones of said output ports respectively, corresponding to wavelengths of the output lights.

13. An optical network comprising:
a plurality of stations; and
optical transmission paths for connecting among said plurality of stations, so as to transmit a wavelength division multiplexed optical signal comprising a plurality of optical signals of mutually different wavelengths;
wherein at least one of said plurality of stations is provided with said optical add/drop multiplexer of any one of claims 10 through 12.

14. An optical switch network comprising:
a plurality of input parts;
a plurality of output ports;
a plurality of wavelength converting means provided corresponding to said plurality of input ports, respectively, for each converting a wavelength of light input from each of said input ports;
a plurality of optical branching/coupling means arranged between said plurality of wavelength converting means and said plurality of output ports;
input side optical switching means for sending the light wavelength converted by each of said wavelength converting means to any one of said plurality of optical branching/coupling means corresponding to the wavelength of the light after conversion and said output port set as an output destination; and
output side optical switching means for sending the light output from each of said plurality of optical branching/coupling means to any one of said plurality of output ports corresponding to the optical branching/coupling means which has output the light and the wavelength of the output light.

15. An optical switch network of claim 14,
wherein said plurality of input ports are divided into plural numbers of groups;
each of said plurality of optical branching/coupling means comprises an optical coupler including input terminals of the numbers equal to said plural numbers of groups and a single output terminal;
said input side optical switching means comprises a plurality of optical switches, each including a single input terminal and output terminals of the numbers equal to said plural numbers of groups, said input terminals of said plurality of optical switches being connected to output terminals of said plurality of wavelength converting means, respectively, in a one-to-one manner, and each of said output terminals of each of said plurality of optical switches being connected to one of input terminals corresponding to said plural numbers of groups, of said plurality of optical couplers; and
said output side optical switching means comprises an arrayed waveguide grating type optical multiplexing/demultiplexing device includeing a plurality of input waveguides connected to said output terminals of said plurality of optical couplers, respectively, in a one-to-one manner, and a plurality of output waveguides connected to said plurality of output ports, respectively, in a one-to-one manner.

16. An optical switch network of claim 14,
wherein said plurality of input ports are divided into plural numbers of groups;
each of said plurality of optical branching/coupling means comprises an optical coupler including input terminals of the numbers equal to the numbers of wavelengths included in each of said groups and output terminals of the numbers equal to said plural numbers of groups;
said input side optical switching means comprises a plurality of optical switches, each including a single input terminal and output terminals of the numbers equal to the numbers of wavelengths included in each of said groups, said input terminals of said plurality of optical switches being connected to output terminals of said plurality of wavelength converting means, respectively, in a one-to-one manner, and each of said output terminals of each of said plurality of optical switches being connected to one of input terminals corresponding to said plural numbers of groups, of said plurality of optical couplers; and
said output side optical switching means comprises a plurality of optical switches, each having input terminals of the numbers equal to the plural numbers of groups and a single output terminal, and a plurality of variable wavelength selectors provided corresponding to said plurality of output ports, respectively, each of said input terminals of each of said plurality of optical switches being connected to one of output terminals corresponding to the plural numbers of groups, of said plurality of optical couplers, such that light of a particular wavelength included in the output light from each of said plurality of optical switches is selected by each of said plurality of variable wavelength selectors and output from the corresponding one of said plurality of output ports.

17. An optical switch network of claim 14, further comprising:
fixed wavelength converting means for converting the wavelength of the light to be transmitted from said output side optical switching means to each of said output ports into a previously set wavelength.

18. An optical cross connecting device comprising:
wavelength-separating means for wavelength separating wavelength division multiplexed light;
an optical switch network including a plurality of input ports to which a plurality of outputs of said wavelength-separating means are connected, respectively;
a plurality of fixed wavelength converting means corresponding to a plurality of output ports of said optical switch network, for converting wavelengths of lights; and
a plurality of wavelength-multiplexing means for wavelength-multiplexing output lights from said plurality of fixed wavelength converting means, respectively;
wherein said optical switch network comprises:
said plurality of input ports;
said plurality of output ports;
a plurality of wavelength converting means provided corresponding to said plurality of input ports, respectively, for converting wavelengths of lights input from said input ports, respectively;
a plurality of optical branching/coupling means arranged between said plurality of wavelength converting means and said plurality of output ports;
input side optical switching means for sending the light wavelength converted by each of said wavelength converting means to any one of said plurality of optical branching/coupling means corresponding to the wavelength of the light after conversion and said output port set as an output destination; and
output side optical switching means for sending the light output from each of said plurality of optical branching/coupling means to any one of said plurality of output ports corresponding to the optical branching/coupling means which has output the light and the wavelength of the output light.

19. An optical cross connecting device of claim 18,
wherein said wavelength-separating means wavelength-separates the input light into a plurality oflights according to wavelength bands, and further wavelength-separates said plurality of lights into a plurality of lights of mutually different wavelengths in each wavelength bands, respectively.

20. An optical cross connecting device of claim 18,
wherein said plurality of wavelength-multiplexing means wavelength-multiplexes the input lights into a plurality of lights according to wavelength bands, and for further wavelength-multiplexes said plurality of lights in said wavelength bands into a wavelength division multiplexed light.

21. An optical add/drop multiplexer comprising:
a dropping section for dropping predetermined optical signals from a wavelength division multiplexed optical signal comprising a plurality of optical signals having been wavelength-multiplexed;
an adding section for adding predetermined optical signals into the wavelength division multiplexed optical signal output from said dropping section; and
an optical switch network for changing directional paths of the predetermined optical signals output from said dropping section into predetermined directional paths;
wherein said optical switch network comprises:
a plurality of input ports;
a plurality of output ports;
a plurality of wavelength converting means provided corresponding to said plurality of input ports, respectively, for converting wavelengths of lights input from said input ports, respectively;
a plurality of optical branching/coupling means arranged between said plurality of wavelength converting means and said plurality of output ports;
input side optical switching means for sending the light wavelength converted by each of said wavelength converting means to any one of said plurality of optical branching/coupling means corresponding to the wavelength of the light after conversion and said output port set as an output destination; and
output side optical switching means for sending the light output from each of said plurality of optical branching/coupling means to any one of said plurality of output ports corresponding to the optical branching/coupling means which has output the light and the wavelength of the output light.

22. An optical add/drop multiplexer comprising:
a dropping section for dropping predetermined optical signals from a wavelength division multiplexed optical signal comprising a plurality of optical signals having been wavelength-multiplexed;
an adding section for adding predetermined optical signals into the wavelength division multiplexed optical signal output from said dropping section; and
an optical switch network for changing directional paths of input optical signals, so as to output the input optical signals to said adding section;
wherein said optical switch network comprises:
a plurality of input ports;
a plurality of output ports;
a plurality of wavelength converting means provided corresponding to said plurality of input ports, respectively, for converting wavelengths of lights input from said input ports, respectively;
a plurality of optical branching/coupling means arranged between said plurality of wavelength converting means and said plurality of output ports;
input side optical switching means for sending the light wavelength converted by each of said wavelength converting means to any one of said plurality of optical branching/coupling means corresponding to the wavelength of the light after conversion and said output port set as an output destination; and
output side optical switching means for sending the light output from each of said plurality of optical branching/coupling means to any one of said plurality of output ports corresponding to the optical branching/coupling means which has output the light and the wavelength of the output light.

23. An optical add/drop multiplexer comprising:
a dropping section for dropping predetermined optical signals from a wavelength division multiplexed optical signal comprising a plurality of optical signals having been wavelength-multiplexed;
an adding section for adding predetermined optical signals into the wavelength division multiplexed optical signal output from said dropping section;
a first optical switch network for changing directional paths of the predetermined optical signals output from said dropping section into predetermined directional paths; and
a second optical switch network for changing directional paths of input optical signals, so as to output the input optical signals to said adding section;
wherein each of said first optical switch network and said second optical switch network comprises:
a plurality of input ports;
a plurality of output ports;
a plurality of wavelength converting means provided corresponding to said plurality of input ports, respectively, for converting wavelengths of lights input from said input ports, respectively;
a plurality of optical branching/coupling means arranged between said plurality of wavelength converting means and said plurality of output ports;
input side optical switching means for sending the light wavelength converted by each of said wavelength converting means to any one of said plurality of optical branching/coupling means corresponding to the wavelength of the light after conversion and said output port set as an output destination; and
output side optical switching means for sending the light output from each of said plurality of optical branching/coupling means to any one of said plurality of output ports corresponding to the optical branching/coupling means which has output the light and the wavelength of the output light.

24. An optical network comprising:
a plurality of stations; and
optical transmission paths for connecting among said plurality of stations, so as to transmit a wavelength division multiplexed optical signal comprising a plurality of optical signals of mutually different wavelengths;
wherein at least one of said plurality of stations is provided with said optical add/drop multiplexer of any one of claims 21 through 23.
